(19) United States
(12) Patent Application Publication
(10) Pub. No.: US 2007/0192157 A1
(43) Pub. Date: Aug. 16, 2007

(54) Interactive system for managing, tracking and reporting work and staff performance in a business environment

(76) Inventor: Elizabeth Ann Gooch, Staffordshire (GB)

Correspondence Address: FISH & RICHARDSON P.C., P.O. BOX 1022, MINNEAPOLIS, MN, 55440-1022, US

(21) Appl. No.: 11/501,140

(22) Filed: Aug. 8, 2006

Related U.S. Application Data
(60) Provisional application No. 60/774,093, filed on Feb. 15, 2006.

(51) Int. Cl. G06F 15/02

(52) U.S. Cl. 705/9

(57) ABSTRACT

Tracking flow of work includes storing setup information in a database in which the setup information includes tasks to be performed. The tasks are allocated to users designated to perform the tasks and details of completed tasks are stored in the database. Users may receive information relating to tasks and staff members as well as reports based on setup information, forecast information or details of completed tasks.

### CROSS-REFERENCE TO RELATED APPLICATION(S)

This application claims the priority of U.S. Provisional Patent Application No. 60/774,093, filed on Feb. 15, 2006. The disclosure of that application is incorporated herein by reference.

### BACKGROUND

This disclosure relates to the managing, tracking and reporting of work and staff performance in a business environment through the use of an interactive graphical interface.

In many companies and industries, it is desirable to improve business performance by decreasing operating costs and increasing the efficiency of work performed. Sources of inefficiency and high cost may be due, in part, to work that is either done incorrectly, not on-time, or both. For example, employees lacking adequate training for performing a particular task may take significantly more time to complete the task than others at an appropriate skill level with sufficient training and experience. Alternatively, an employee or team of employees may complete an assigned task incorrectly. The additional time necessary to accomplish the task or correct errors leads to a growing backlog of work and an increase in product cycle times.

Typically, it is the role of a manager or team leader within a business to supervise both employees and the work performed such that the sources of inefficiency and increased costs are diminished. Such supervision entails, for example: scheduling and allocating work according to both the resources available and the skill sets of employees; tracking work from receipt to finish in order to ensure timely completion; monitoring the quality of work; and requiring that employees are adequately trained. Furthermore, the manager may be responsible for reporting on work throughput and productivity while at the same time planning and forecasting future staffing requirements, employee skills, and workload.

However, it is often difficult to provide the manager or team leader with the level of detail regarding work flow and employee skills necessary to implement improvements, report on work throughput or plan for future needs. Such information itself may require extensive time and effort to collect and produce. Furthermore, this knowledge may be out of date by the time it is prepared or received by the manager.

### SUMMARY

In one aspect, monitoring the flow of work can be accomplished by a system that includes a communication network, a user device that includes a display connected to the communication network, a server connected to the communication network and a database. The database stores information relating to setup, tasks that are to be performed and tasks that have been completed.

The servers are configured to present an interactive program on the display, through the communication network, which allows users to enter information into the database relating to setup, tasks to be performed and completed tasks.

The servers also are configured to deliver information in response to a request received from a user in which the delivered information includes tasks allocated to a user, and information relating to the allocated task or information relating to a staff member. The delivered information also includes a report based on setup information, forecasting information or information relating to completed tasks. In some implementations, the setup information can include information relating to a department, section or staff member. The completed task information can include the quality of each completed task, a time stamp of when each task was completed or an amount of time taken to complete each task.

In another aspect, tracking flow of work includes storing setup information in a database in which the setup information includes tasks to be performed. The tasks are allocated to users designated to perform the tasks and details of completed tasks are stored in the database. Users may receive information relating to tasks and staff members as well as reports based on setup information, forecast information or details of completed tasks.

Some implementations include one or more of the following features. For example, the report may include a graphical report which displays the status of both allocated and unallocated tasks, staffing levels, staff member attendance, staff member skills, staff member progress and performance, section progress and performance, department progress and performance, quality of completed tasks, staff member cost information, work cost information and department, section and staff trends.

Tasks can be automatically allocated to a user based on availability of the user, an attendance schedule of the user or a skill level of the user.

A second task can be automatically allocated to a user who is designated to perform the second task based on completion of a first task. The second task may also be automatically allocated to the second user if a predetermined period of time has elapsed since completion of the first task or a due date for completion of the first task has passed.

A second group of tasks may be automatically allocated to users designated to perform the second group of tasks after a first group of tasks are completed. Automatic allocation of the second group of tasks to users may also occur if a predetermined period of time has elapsed since completion of the first group of tasks or a due date for completion of the first group of tasks has passed.

An amount of time to complete each task can be determined based on a skill level of a user designated to perform the task, the difficulty of the tasks to be performed, or the users available to complete the task. The number of users to complete the tasks may be determined based on skill levels of users available to perform the tasks as well as the difficulty of the tasks to be performed.

Future staffing needs may be determined based on the volume, difficulty and scheduled completion dates of the tasks to be performed.

A quality of a completed task can be determined based on errors committed by a user performing the task.

A performance of a user may be determined based on a skill level of the user, how often the user completes each task on time and the quality of the tasks completed by the user.

Each task can be allocated based on a volume of tasks to be performed and scheduled completion dates for each task.

These general and specific aspects may be implemented using a system, a computer-implemented method, or a computer program, or any combination of systems, computer-implemented methods, and computer programs.

Certain implementations may have one or more of the following advantages. The system allows managers and team leaders to efficiently schedule their work and plan how to use their resources in order to meet customer requirements. Work can be automatically allocated according to the skills of available employees and tracked from receipt to successful completion leading to, for example, a reduction in work related errors as well as fair distribution of work. Furthermore, the automatic allocation of work may help increase work throughput by reducing backlogs. The system allows work quality, throughput, backlogs and staff productivity, skills and performance be viewed across a business providing managers with an up-to-date status of a business's resources. Quality, performance and throughput may be analyzed among individuals, sections and entire departments of a business. Users may assign or access work from any location within the business. The system also reduces the time necessary for managers to sort staff member or work related data.

The details of one or more implementations of the invention are set forth in the accompanying drawings and the description below. Other aspects, features and advantages of the invention will be apparent from the description, drawings and the claims.

### DESCRIPTION OF DRAWINGS

FIGS. 1A-1C illustrate example configurations of an interactive computer system.

FIG. 2 shows an example of the type of data that may be stored in an information database.

FIG. 3 illustrates a block diagram of the system operation.

FIG. 4 illustrates an example of a main screen that is displayed to a user.

FIG. 5 shows an example of a department information entry screen.

FIGS. 6A-6D illustrate example section details screen.

FIG. 7 shows an example of a section working hours entry screen.

FIGS. 8A-8B illustrate examples of staff information screens.

FIG. 9 shows an example of a task entry screen.

FIG. 10 illustrates an example of a staff competency level entry screen.

FIGS. 11A-11B show examples of process creation screens.

FIG. 12A illustrates an example of a linked tasks screen.

FIG. 12B illustrates an example of a linked processes screen.

FIG. 13 shows an example of a quality attribute assignment screen.

FIG. 14 is an example of a milestone set-up screen.

FIG. 15 shows an example of a work entry screen.

FIG. 16 illustrates an example of a case inquiry screen.

FIG. 17 shows an example of a case activity screen.

FIG. 18 is an example illustration of a section attendance screen.

FIG. 19 illustrates an example of a work allocation screen.

FIG. 20 illustrates an example auto allocation settings screen.

FIG. 21 shows an example illustration of a quality collection screen.

FIG. 22A shows an example of a staff member work screen.

FIG. 22B illustrates an example of a case detail window.

FIG. 23 shows an example Book Out Confirmation window.

FIG. 24A illustrates an example capacity plan report generation window.

FIG. 24B illustrates an example capacity plan report.

FIG. 25A shows an example skills matrix report generation window.

FIG. 25B illustrates an example skills matrix report.

FIGS. 26A-26B illustrate example progress charts.

FIG. 27A shows an example individual performance report generation window.

FIG. 27B illustrates an example individual performance report.

FIG. 28A is an example illustration of a section performance report generation window.

FIG. 28B illustrates an example screen of a section performance report.

FIG. 29A illustrates an example of an end-to-end process analysis report generation window.

FIG. 29B illustrates an example of an end to end analysis report.

FIG. 30A illustrates an example of a quality summary report generation window.

FIG. 30B illustrates an example of a quality summary report.

FIG. 31A illustrates an example quality attribute summary report generation window.

FIG. 31B shows an example of a quality attribute summary report.

FIG. 32A shows an example of an age analysis report generation window.

FIG. 32B shows an example of an age analysis report.

FIG. 33 shows an example login screen.

FIG. 34 illustrates a screen which shows a list of module applications.

FIG. 35 shows an example of a questionnaire assignment screen.

Like reference symbols in the various drawings indicate like elements.

### DETAILED DESCRIPTION

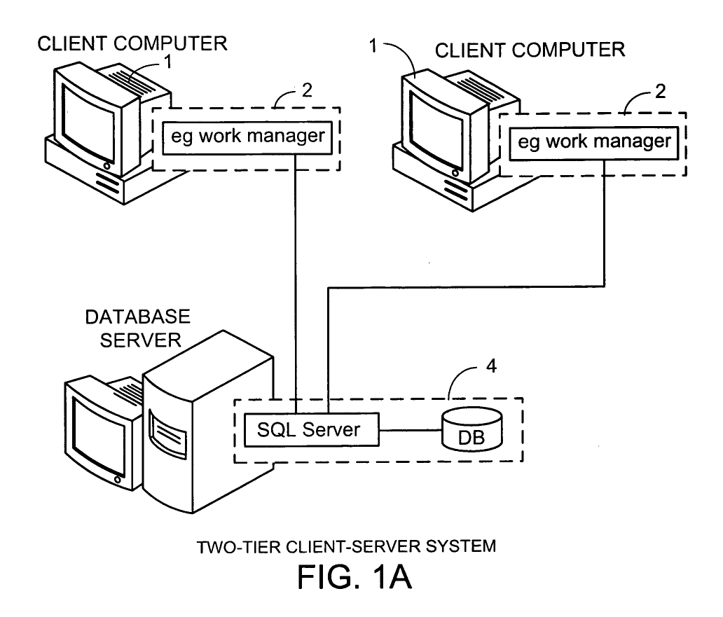

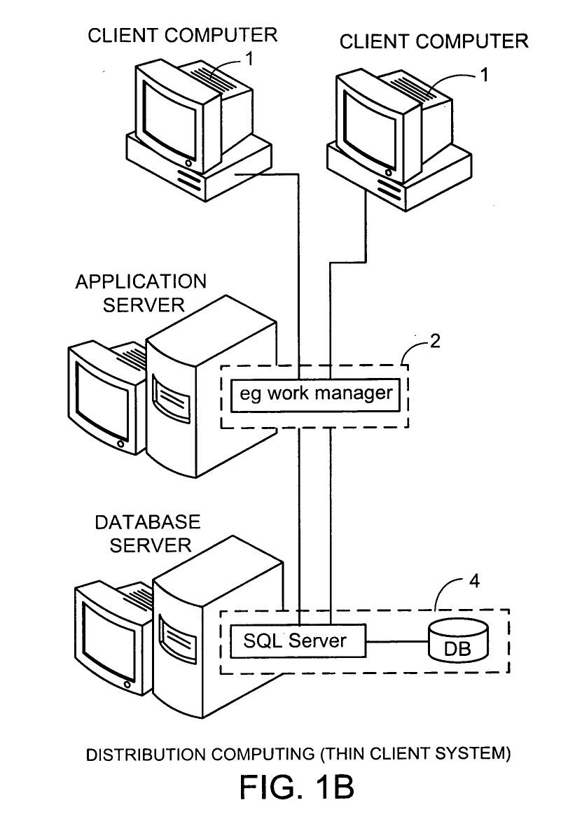

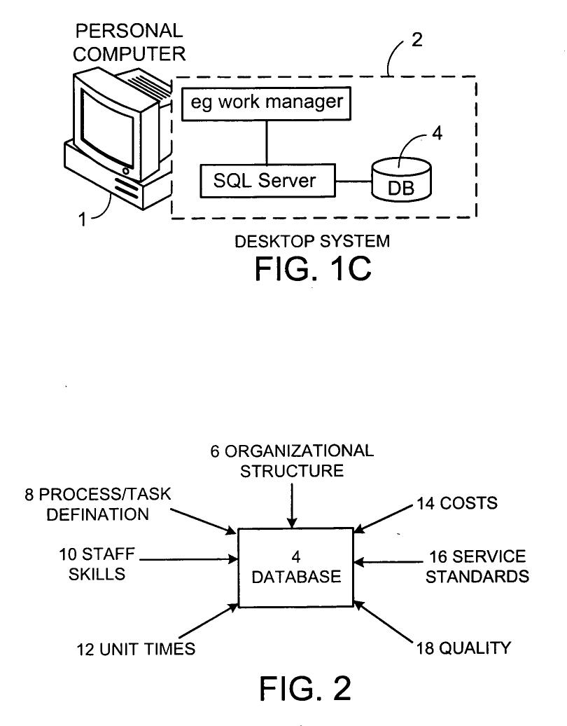

FIGS. 1A-1C show examples of an interactive computer system that enables a user (e.g., manager, employee or staff member of a business) or several users to enter data into and retrieve data from a software application 2 and an information database 4. The user uses a device with a graphical display such as a personal computer 1 to interact with the software application 2 and the information database 4. Based on data obtained from the information database 4 or entered by the computer 1, the software application 2 executes logic calculations and displays an output on a display monitor associated with the computer 1.

The configuration shown in FIG. 1A is a two-tier client/server configuration in which the software application 2 resides on the computer 1 and the information database 4 resides on a database server 5. The software application 2 residing on computer 1 connects over a network to the server that stores the information database 4. This network may include, for example, the Internet, an intranet, a local area network, a wireless network or any other network that allows transmission of data between the computer 1 and database server 5. In this configuration, multiple computers 1 and software applications 2 may be used to connect to a single information database 4.

FIG. 1B shows a distributed computing or a “thin client” configuration in which the software application 2 resides on an application server 3 and the information database 4 resides on a database server 5. Data and information are transmitted between the computer 1, the application server 3 and the database server 5 over a network. All of the logic processing performed by the software application 2 occurs on the application server 3. As above, such a network may include, for example, the Internet, an intranet, a local area network, a wireless network or any other network that allows transmission of data between the computer 1, the application server 3 and the database server 5. Multiple computers 1 may be used in the thin client configuration.

The third configuration is a desktop system shown in FIG. 1C. In this configuration, both the software application 2 and information database 4 reside on a single client computer 1.

FIG. 2 is a block diagram illustrating some examples of the type of data that can be entered into the information database 4 during set-up of the system. This data may be entered through the computer 1. The data may be a set of parameters that include information relating to different aspects of an existing business as well as any work within the company that has been, or will be, performed. In the example shown in FIG. 2, the parameters may include organizational structure, processes/tasks, staff skills, unit times, costs, service standards and work quality.

The parameter organizational structure 6 refers to the business hierarchy. That is to say, an entire business may be divided, for example, into separate divisions or departments such as accounting, sales, etc. Each department may be further divided into teams or sections. Each section can include one or more individuals (i.e., staff members and employees). Staff members may work for more than one section.

The process/task definition parameter 8 shown in FIG. 2 refers to the creation of tasks and processes within a business. A task can include a single, manageable piece of work that can be completed in one sitting. If the piece of work is to be performed multiple times, a volume may be entered for that task. A process may represent either a single task or a series of tasks. In addition, a process may include other processes called sub-processes. Tasks may be allocated to one or more staff members.

The staff skills parameter 10 refers to the skill level for each employee per task. The skill level can indicate, for example, the ability of an employee to perform a particular task or set of tasks correctly and on-time. Staff skills also may represent the amount of training or level of experience for each employee of the business.

The unit times parameter 12 specifies the standard length of time an employee preferably takes to complete a particular task or set of tasks. This parameter may provide a target against which a manager can compare employee performance.

The costs parameter 14 may indicate, for example, any cost information relevant to obtaining the unit cost of an item produced by the business or a service the business provides.

The service standard parameter 16 can be the maximum amount of time set for a task or process to be completed. The software application 2 may use service standards to calculate target dates that specify the dates by which work must be completed.

The quality parameter 18 denotes how the quality of a particular task/process can be measured and may be based on, for example, the errors and appearance of the completed work.

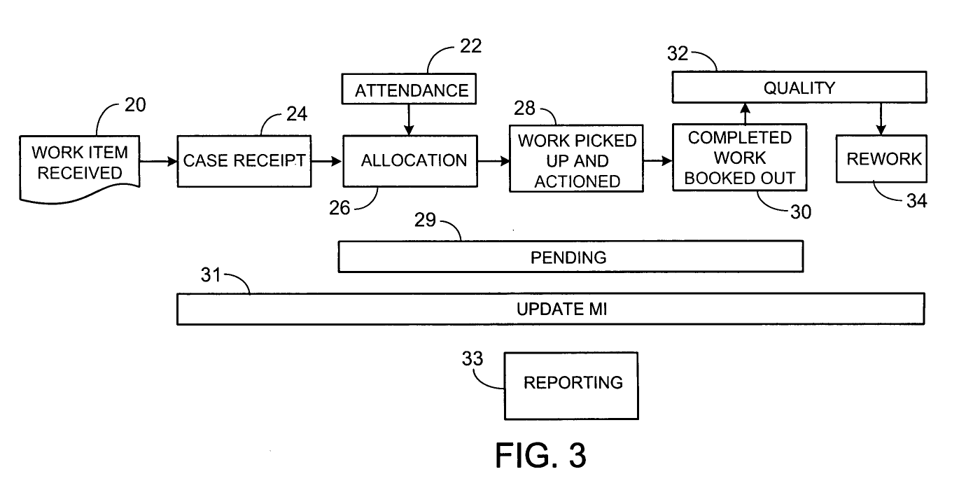

FIG. 3 illustrates a block diagram of the system's operation. After setup, a user may enter work 20 and attendance 22 information into the database 4 through the computer 1. The process of entering work details is performed in the case receipt 24 block. The next block is allocation of work 26. A user may manually allocate the work to staff members or have the work allocated automatically by the system based on the attendance, staff skills and other information available in the database 4. Following work allocation 26, staff members may access and complete the work 28. A staff member typically indicates work is completed by performing a “book out” step 30 which notifies the system that the task is completed. Work may be described as pending 29 during the process of allocating, performing and “booking out.” Completed work may be sampled 32 for quality to ensure work is being performed correctly and efficiently. In some cases, the work may need to be reworked 34 (i.e., redone). During each step, the system is updated 31 to reflect current state of the business. The software application 2 performs logic operations based on the parameters stored in the information database 4 as well as data entered by a user using the computer 1. The output of the logic operations may provide information to the user that can be utilized to aid in tracking and improving business performance. Using the data plus parameters entered during set-up, the software application 2 can output reports 33 that enable a user to monitor many aspects of a business operation. The reports may include, for example: information on work received, completed, pending and outstanding; quality of work performed; productivity levels; staffing levels; unit costs; staff skill levels and training needs; and trend information.

System Set-Up

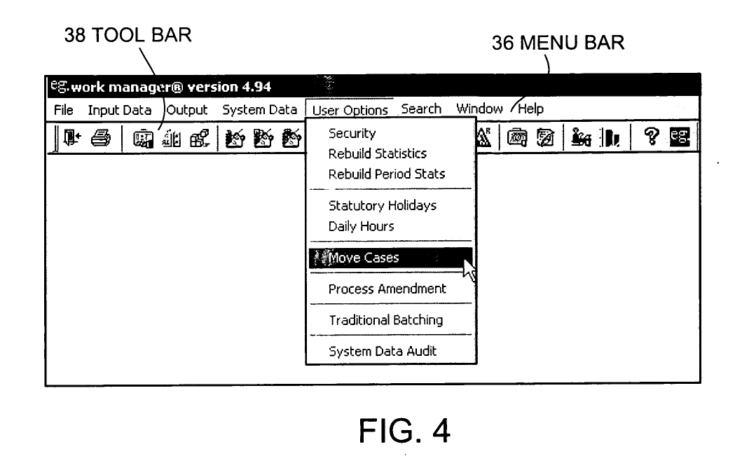

A user may access and edit data entered into the interactive computer system via an application link on the client computer. FIG. 4 illustrates an example of the main screen that is displayed to the user after accessing the software application 2. The main screen may include a toolbar 36 and menu bar 38 from which a user may select different functions.

During set-up of the system, a user, such as a database administrator, enters information into the database 4. This information can include organizational structure, processes/tasks, staff skills, unit times, service standards, costs, and work quality.

During set-up, a user will typically first enter information into the database 4 related to the organizational structure. The parameter organizational structure refers to the organization hierarchy. That is to say, an organization may be divided, for example, into separate divisions or departments that each serves one or more particular aspects of a business. Such departments may include, for example, accounting, sales, etc. Each department may be further divided into section or teams. Each team can include one or more individuals or employees of the organization also known as staff members.

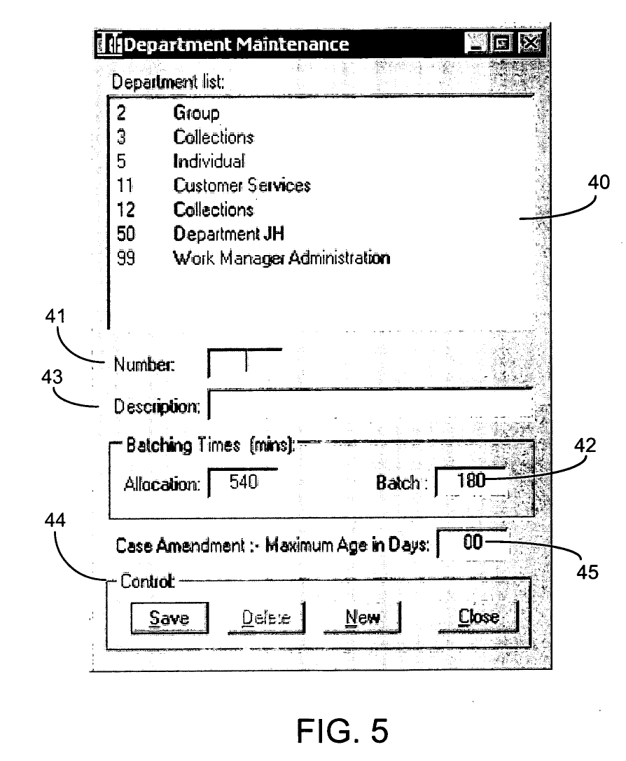

To enter department information into the database 4, a user accesses the department entry screen or window by selecting the appropriate link from the main entry screen. The department entry screen displays details relating to any departments within the organization and allows users to create new departments or edit and delete pre-existing ones. In the example of FIG. 5 a department entry screen entitled “Department Maintenance” is shown. The screen can be divided into several regions: a list window 40 labeled “Department list” that displays a record of all departments within the organization that have been previously created; a batching times frame 42 in which a user may set the maximum amount of time and number of tasks that can be allocated to an individual within the department; and a control frame 44 for activating new departments, deleting old ones, saving changes and exiting out of the “Department Maintenance” window. Each department presented in the list window may include a brief description or label and a corresponding number. Below the list window are number 41 and description 43 entry fields. When creating a new department, a user enters the department number and brief description of the department into these fields. The new department is created by selecting the “New” button from the control frame 44. Alternatively, a user may edit the number 41 and description 43 by highlighting the department from the list window, modifying the field entries, and then selecting the “Save” button to save this updated information. Likewise, a department may be deleted by highlighting the selection from the list window 40 and selecting “Delete.” To return to the main screen, a user may select “Close.” In the case amendment field 45, a user may enter the maximum number of days after a case is received that the system permits a user to make amendments to the case, for example, changing the target date, volume or task.

Information regarding a team or section may be entered into the database 4 in a similar manner. After selecting the appropriate link from the main screen, a section detail screen may be displayed. The section detail screen allows a user to create, edit, and delete sections or teams as well as enter section information that may be used in generating reports and tracking work progress. Section information can include: basic information such as section name and staff size; more detailed information such as how much work a section can be assigned and the competency of a section; time-off and performance goals; and what fields to display in section reports.

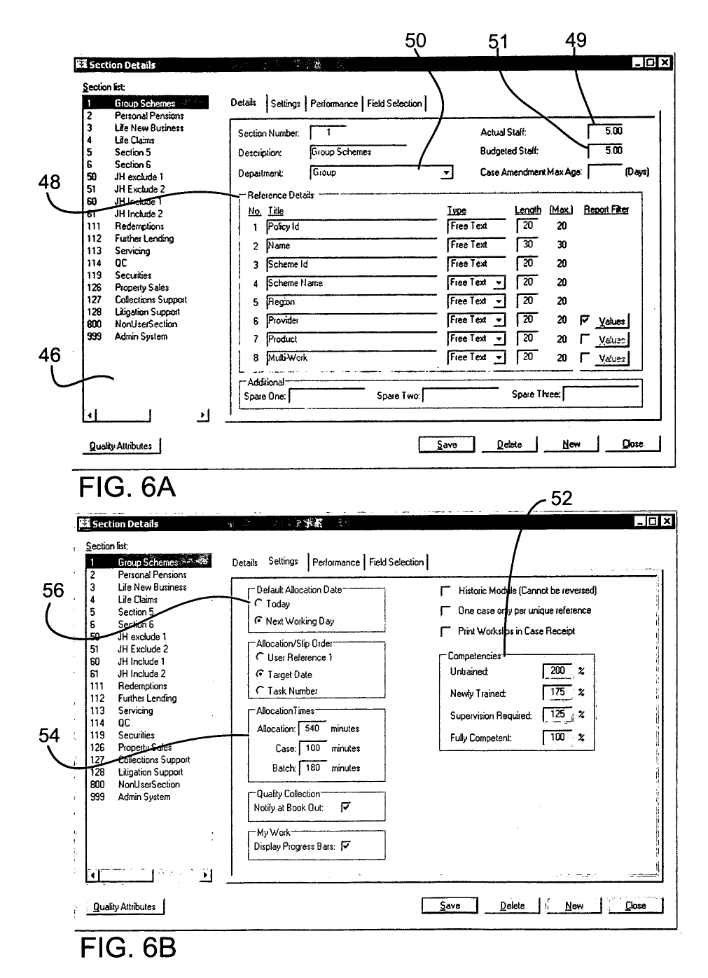

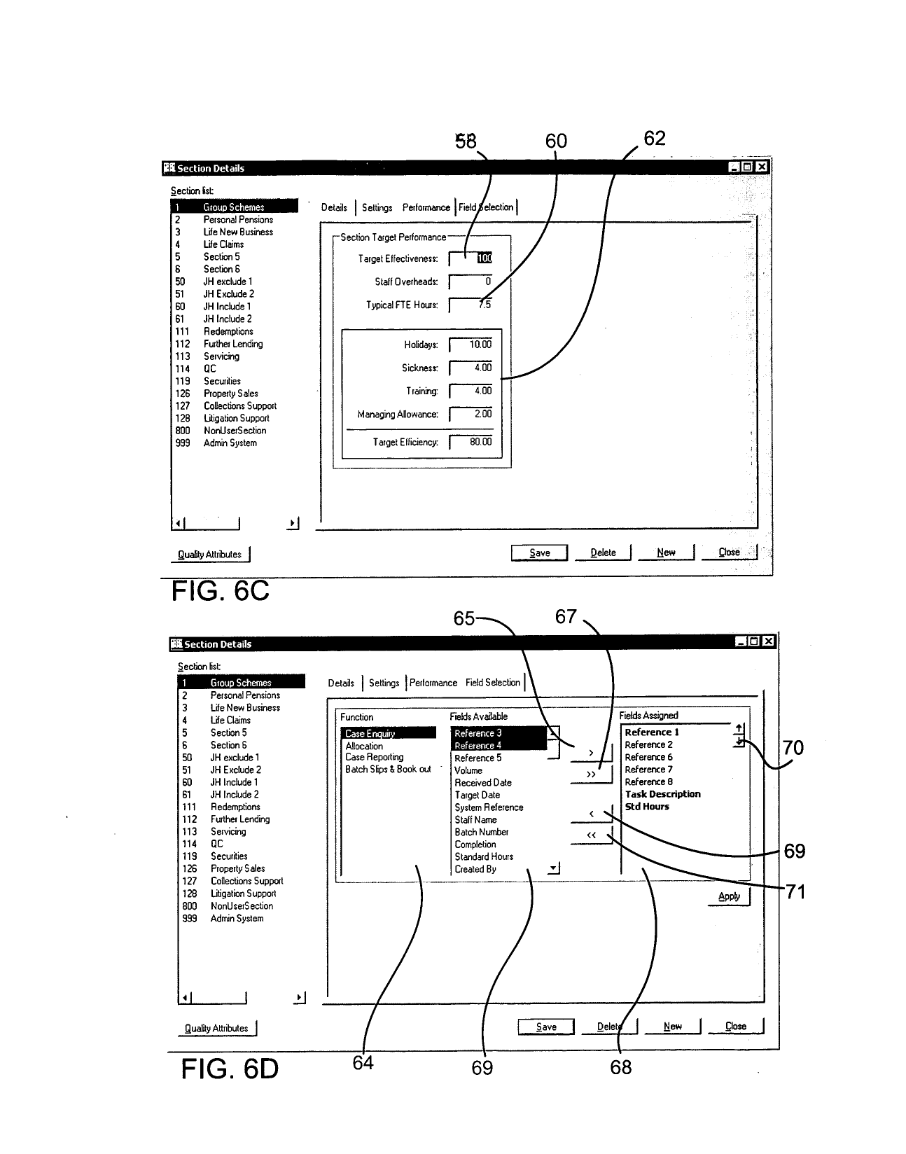

An example section detail screen is shown in FIG. 6A. In this example, a section list window 46 is located on the left side of the screen. The section list window displays existing sections by a number and brief description. As with the department entry screen, a user can create, edit, or delete sections. Section information may be separated into distinct categories. As shown in the example of FIG. 6A, these categories are accessed by selecting one of the tabs at the top of the section detail screen. The first tab in this example is labeled “Details.” Under the “Details” tab, a user may enter the working parameters for the sections within each department. For example, a user may define the number of staff and section competencies, the section number and a brief description of the section. The reference detail fields 48 may be used to further define work that as it is received. Additionally, a department drop down list 50 allows the user to assign the section to a particular department that has been created in the department entry screen. In the actual staff field 49, a user may enter the full time equivalent number of staff in the section. In the budgeted staff field 51, a user may enter the number of staff budgeted for in the section.

The next category in this example is indicated by the “Settings” tab. Upon selecting this tab, a user may enter information relevant to work performed by a particular section. As shown in FIG. 6B, a user may enter the competencies of staff members in the competency data fields 52. In the Untrained field, a user can enter the percentage competence factor that may apply to individuals that are untrained. In the Newly Trained field, a user can enter the percentage competence factor that may apply to individuals that are newly trained. In the Supervision Required field, a user can enter the percentage competence factor that may apply to individuals that require supervision. In the Competent field, a user can enter the percentage competence factor for individuals that do not require supervision. In the Allocation Times field 54, a user can enter the maximum amount of work that may be assigned to a staff member in a working day. In the Default Allocation Date area 56, a user can select whether you the system will use the current date or the next working day to allocate tasks.

The third category is shown in the example of FIG. 6C as the “Performance” tab. Under the “Performance” category, a user can modify information pertaining to the target performance level of staff members within a section. This information can include: the target effectiveness which is the minimum permitted level of effectiveness a business may require in each section; the full time equivalent (FTE) which is the equivalent number of full-time staff that a section represents; and the preferred maximum percentage of time allowed for holidays, sickness and training. In this particular example, target effectiveness may be entered as a percentage in the data field 58. The number of standard hours a user may expect a full time individual to work in a day can be entered in the FTE Hours data field 60. The preferred maximum percentage of time allowed for holidays, sickness and training may be entered in the data fields 62.

FIG. 6D shows a fourth category of the section detail screen labeled “Field Selection.” Under this category, a user may select data fields that will be displayed in other screens and reports generated by the application software 2. The data fields available for selection may be chosen from a predetermined list. Each class of report/screen generated by the application software 2 can have its own corresponding predetermined list of data fields from which the user can select. In the example of FIG. 6D, there are three separate list windows: the Function List window 64, the Fields Available list window 66, and the Fields Assigned list window 68. The Function List window 64 displays the different classes of reports that may be generated within the software application 2. Once a specific class of report has been highlighted by the user, the Fields Available list window 66 displays a scroll-down list of data fields that may be viewed in the report. A user can then select one or more fields from the Fields Available list window 66. A field will not be displayed in a report, though, until it has been assigned. Once selected from the Fields Available list window 66, the one or more fields may be assigned to the corresponding report by clicking the Assign Fields button 65. Alternatively, a user may wish to assign all fields from the Fields Available list window 66. For this purpose, the user may select the Assign All Fields button 67. The recently assigned fields will then appear in the Fields Assigned list window 68. Reports generated by the application software 2 display the assigned data fields. Users may also remove assigned fields from the Fields Assigned list window 68 by selecting the Remove Fields button 69 or the Remove All Fields button 71. Reports generated by the application software 2 will not display the fields that have been removed from the Fields Assigned list window 68. The assigned data fields are listed in the Fields Assigned list window 68 corresponding to the order in which they appear in the generated report, i.e. top to bottom. This order may be rearranged by selecting either the up or down selection buttons 70. Data fields listed in bold within the Fields Assigned list window 68 can represent mandatory fields, i.e., fields that cannot be removed from the Fields Assigned list window 68.

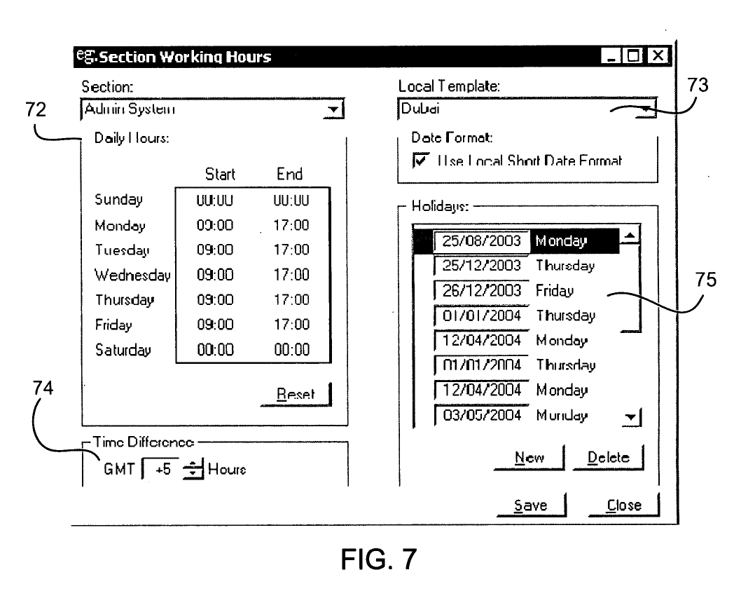

In some implementations, a user may also enter information related to a section's working hours. For example, a user may open the “Section Working Hours” screen as shown in FIG. 7. In the illustrated implementation, a user may enter or modify the official daily start and end times for each section under the Daily Hours frame 72. Additionally, a user may adjust the local time in the Time Difference frame 74 for sections that are located in different time zones. Furthermore, a user may change the format in which time is presented to sections by selecting a template from the Local Template drop-down window 73. Also, a user may adjust a section holiday schedule by creating and removing holidays from the Holiday scroll-down list 75.

Staff member information may be entered by the user in a staff information screen. From the staff information screen, a user can add and delete staff members or modify staff information. Furthermore, a user may assign one or more staff members to any section or sections that have been previously created. Staff information may include, for example, the staff member name, salary, skill level, start date and termination date. A user may also modify staff member security privileges from a staff information screen.

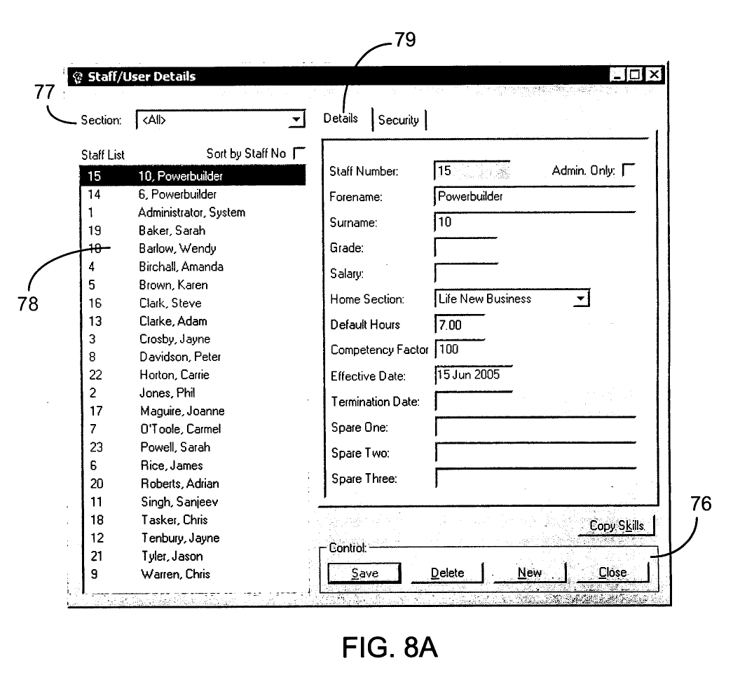

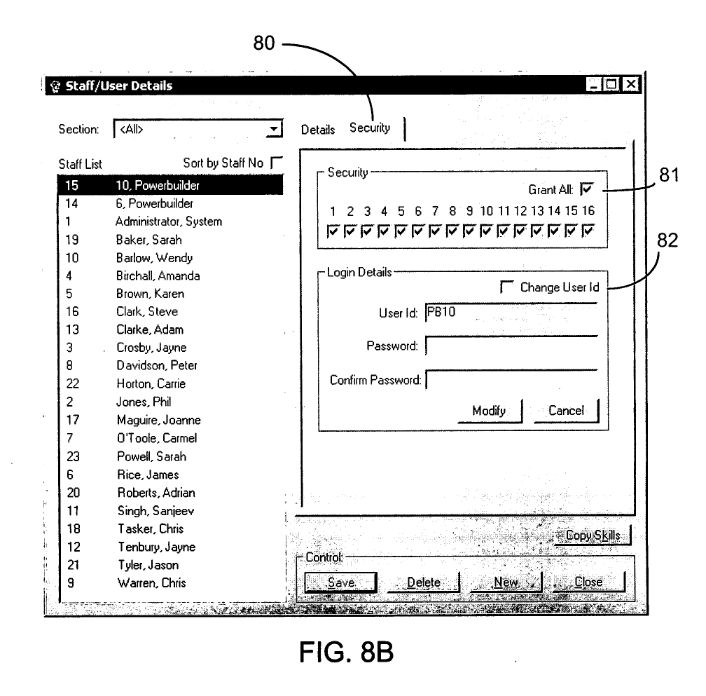

FIG. 8A illustrates an example of a staff information screen, labeled “Staff/User Details.” As in previous examples, the staff information screen may include a Control section 76 for the purpose of creating or deleting staff members in the information database 4 or for saving changes to staff member details. A user may highlight or select a particular staff member from the Staff List window 78. Typically, a new staff member is created by first selecting the section to which the staff member will be assigned. Sections are chosen from the Section drop-down window 77. Anew staff member may then be assigned to the selected section by clicking the “New” button from the Control section 76. In this example, details of the new staff member can then be entered in the fields under the Staff Details tab 79. The user may choose to enter staff detail information that includes, for example, forename, surname, salary level, standard working hours and start date.

FIG. 8B illustrates an additional staff information screen for establishing security privileges of staff members. In this example, security details may be entered in fields under the Security tab 80. Such fields may include, for example, a Security Level frame 81 in which a user can set the appropriate staff member security level. Additionally, this screen may include Login entry fields 82 to ensure that only appropriate users may alter the security settings.

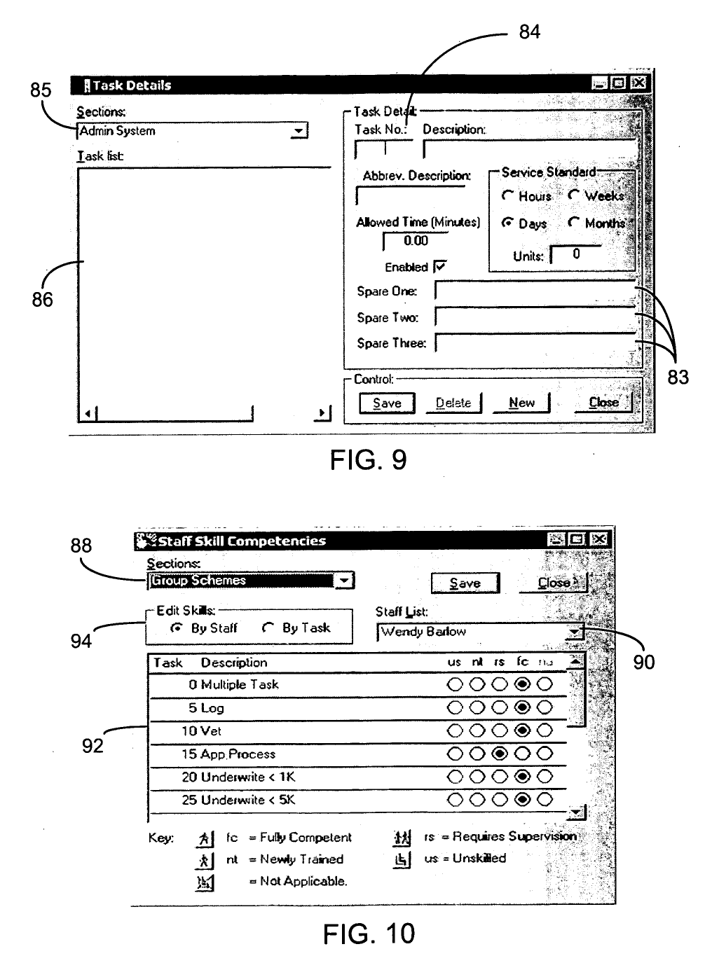

Once the organizational structure has been entered into the database 4, a user may enter task information. A task can be a business or work activity that may be completed by a single staff member. Although in some cases it may be worked on by multiple staff members. Tasks can include assignments that may be accomplished in one sitting or over an extended period of time. For example, a task may include placing a work order or examining customer records. Tasks may be created individually by entering the task information in a task entry screen. An example of a task entry screen is shown in FIG. 9. In the example task entry screen, a user may enter task data into fields available within the Task Detail frame 84. In this implementation, the task data can include task number, task description, abbreviated task description and the standard time necessary to complete the task. Additionally, a user may enter a maximum time allowable for accomplishing a task. In other implementations, Spare fields 83 may be available for entering supplemental task information. Tasks entered into the database 4 may be viewed in the Task List window 86. Additionally, tasks may be assigned to a specific section using the Sections drop-down window 85.

A user may continue to set up the system by assigning skill competencies to each staff member, i.e., ranking the staff member's ability to perform a specific task. An example of a screen in which a user can enter staff skill competency levels is shown in FIG. 10. A user may select the desired team from the Section drop-down window 88 and staff members from the Staff List drop-down window 90. In the illustrated implementation, task number and descriptions are displayed by row in the Task-Skill window 92. To the right of the task description in the Task-Skill window 92, a user can select from several different levels that identify a staff member's ability to perform a task. Preferably, the competency levels correspond to whether a staff member is fully competent (fc), requires supervision (rs), is newly trained (nt) or unskilled (us) with respect to the associated task. If there is no reason to assign a skill competency level to a staff member, the user may select a Not Applicable (“NA”) option. Alternatively, a user may assign skill competency levels to an entire section for each task. For example, in the illustrated implementation, a user may select the “By Task” option in the Edit Skills frame 94. The Staff List drop-down window 90 then changes to a Task List drop-down window (not shown) from which a user may select a particular task. Additionally, the tasks and descriptions listed in the Task-Skill window 92 are replaced by a list of all staff members (not shown) within the selected section.

In some implementations, multiple tasks may be grouped together into a “process.” A process can include a series of tasks that are performed either sequentially or at various times. As before, a task may be completed by a single staff member. However, a single staff member is not required to complete each task within a process. The tasks may be distributed to more than one staff member. Additionally, the tasks may be distributed to staff members from different sections.

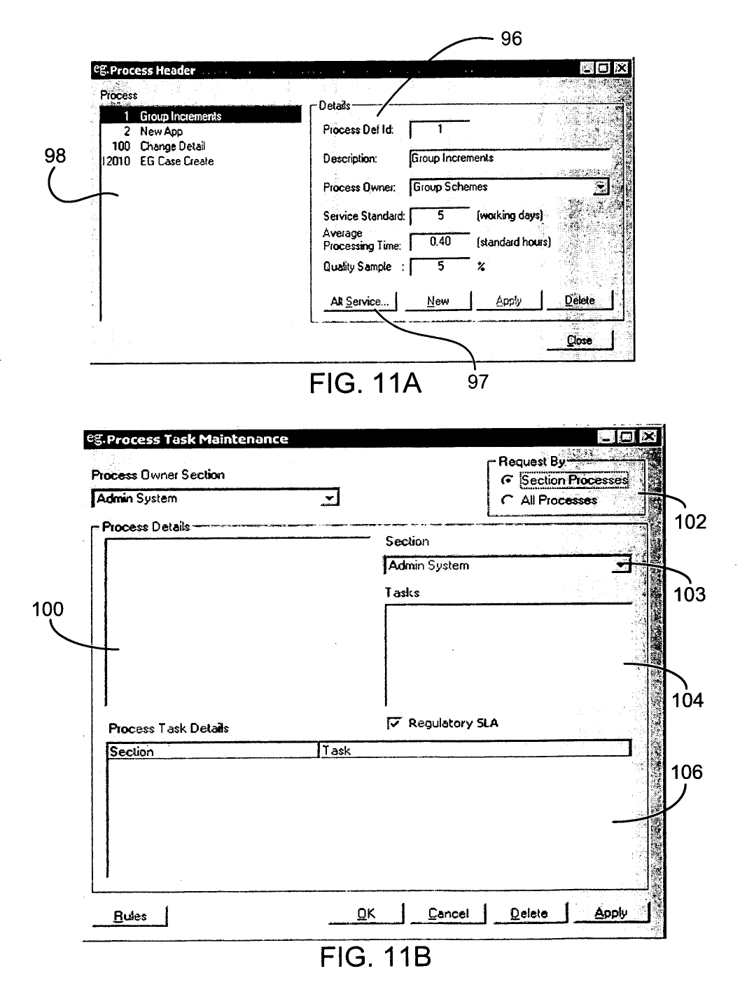

An example of creating a process is shown in FIGS. 11A and 11B. FIG. 11A is an illustration of a process creation screen labeled “Process Header.” Processes may be created or deleted in the process creation screen by selecting the “New” or “Delete” buttons in the Details frame 96. Processes that have been created may appear in the Process window 98. In the illustrated implementation, a user may, for example, enter process details into the data entry fields of the Details frame 96. As shown in FIG. 11A, the process details can include: a process identifier (“Process Def Id”); a description of the process (“Description”); the team or section to which the process belongs (“Process Owner”); the standard service time for completing a process (“Service Standard”); the average processing time which is the average time in standard hours that it takes a fully competent staff member to complete the process; and the percentage of a process that is preferably sampled to ensure performance measures are being met (“Quality Sample”). Additionally, alternative service standards may be created by selecting the Alternative Service button 97.

After creating a process, a user typically assigns a start task to the new process. The start task is the first task in a process. FIG. 11B shows an example screen in which a user may assign a start task. A list of processes may be viewed in the Process Details window 100. Preferably, the user first selects whether all available processes currently saved in the database 4 are viewed in the Process Details window 100 or only the processes owned by a particular section. In order to make this selection, a user may choose either “All Processes” or “Section Processes” from the Request frame 102. For example, if a user selects “Section Processes” from the Request frame 102, a list of processes will be displayed in the Process Details window 100. If, on the other hand, a user instead selects “All Processes” from the Request frame 102, all available processes will be displayed in the Process Details window 100. A user may then highlight a process from the list displayed in the Process Details window 100. A task may be assigned to the highlighted process by dragging a task from the Task window 104 to the Process Task Details window 106. Tasks displayed in the Task window 104 are associated with the section chosen in the Section drop-down window 103.

As mentioned above, tasks within a process may be completed at various times or in sequential order. Tasks completed in sequential order may be linked. A linked task is a task that has one or more links to other tasks. When a first task is completed the link allocates a new or second task. The second task may, in turn, be linked to a third task and so on such that a chain of tasks is formed.

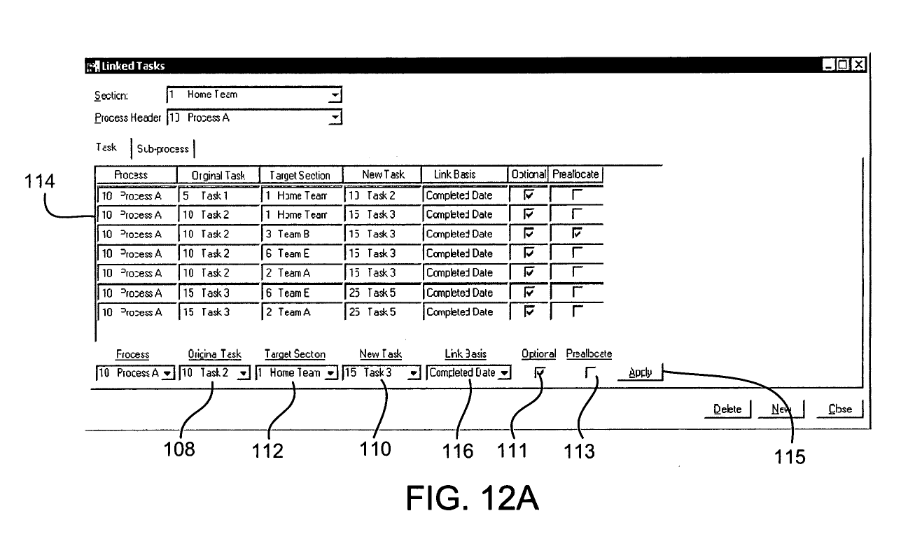

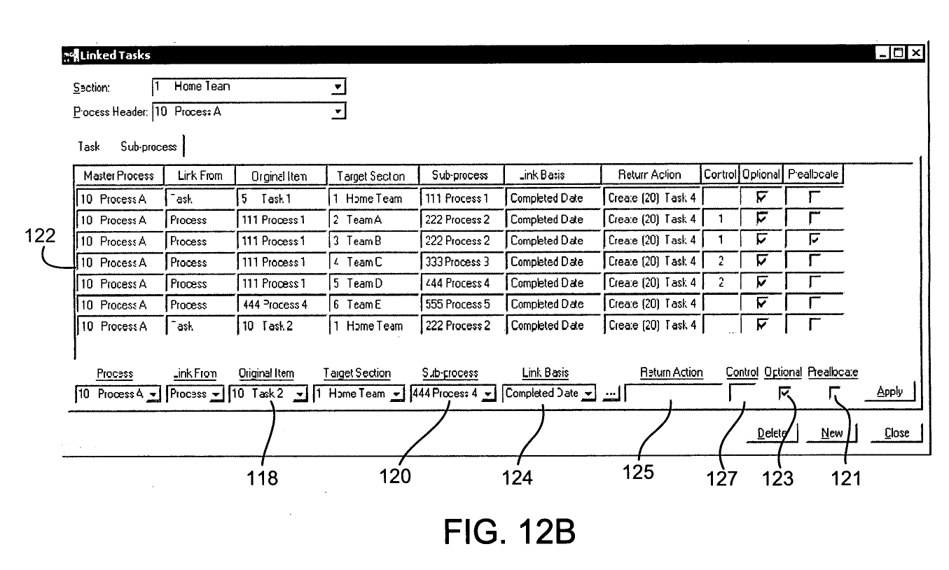

In the present implementation, linked tasks are created by linking two tasks at a time. FIG. 12A illustrates an example screen entitled “Linked Tasks” in which a user may set up and organize linked tasks. In the implementation of FIG. 12A, a user may link tasks by selecting the first task from the Original Task drop-down window 108. A user can then select the second task from the New Task drop-down window 110. The section that will perform the task may be selected from the Target Section drop-down window 112. The new linked tasks may be added to the Linked Task window 114 by clicking on the Apply button 115.

In order to form a chain of linked tasks, the user may simply link each new task to a previously linked task. For example, in the implementation of FIG. 12A, row 1 in the Linked Task window 114 shows a first task (task 1) linked to a second task (task 2). Row 2 in the Linked Task window 114 shows the second task linked to a third task (task 3). Therefore, task 1 is linked to task 2 which is linked to task 3. Linked tasks may be assigned to more than one section, as well. For example, rows 2-4 of the Linked Task window 114 in the implementation of FIG. 12A show that the third task (task 3) may be assigned to more than one section (“Home Team,” “Team B,” “Team E,” and “Team A”).

As discussed above, a task is preferably completed prior to the allocation or commencement of a new task in a set of linked tasks. In some implementations, a user may specify additional criteria that must be satisfied prior to the allocation or commencement of a new task. Such criteria can indicate, for example, 1) a staff member has completed the current task, 2) the next business day has elapsed after completion of the current task or 3) the due date for task completion occurs. In the illustrated implementation of FIG. 12A, a user may select these options from the link basis drop-down window 116.

In some implementations, a user may select an option (Pre-Allocate check box 113) that automatically allocates the new task to a staff member who completes the current task. In some implementations, a user may also select an option (Optional check box 111) that allows the user an opportunity to decide whether or not a linked task will be created after the current task has been booked out. On the other hand, if the check box 111 is not selected, the system automatically activates the link and creates the new task when the user books out the old task.

Similar to linking tasks, a user may also link sub-processes. A sub-process is a process that may be completed within a master process. Sub-processes may be linked from another sub-process or from a task. An example of a window that allows a user to link sub-processes is shown in FIG. 12B. A first process or task can be selected from the Original Item drop-down window 118. A user may then select a second process or task from the Sub-Process drop-down window 120. Linked sub-processes may be displayed in the linked sub-process window 122. In some implementations, a user may select a link basis from the Link Basis drop-down window 124. The link basis includes additional conditions that may be satisfied prior to the allocation or commencement of the next sub-process. For example, a new sub-process can be started when the last task in the current sub-process is completed.

In some implementations, a user may select an option (Pre-Allocate check box 121) that automatically allocates the new sub-process to a staff member who completed the current sub-process or task. In some implementations, a user may also select an option (Optional check box 123) that generates a new sub-process upon completion of the current sub-process.

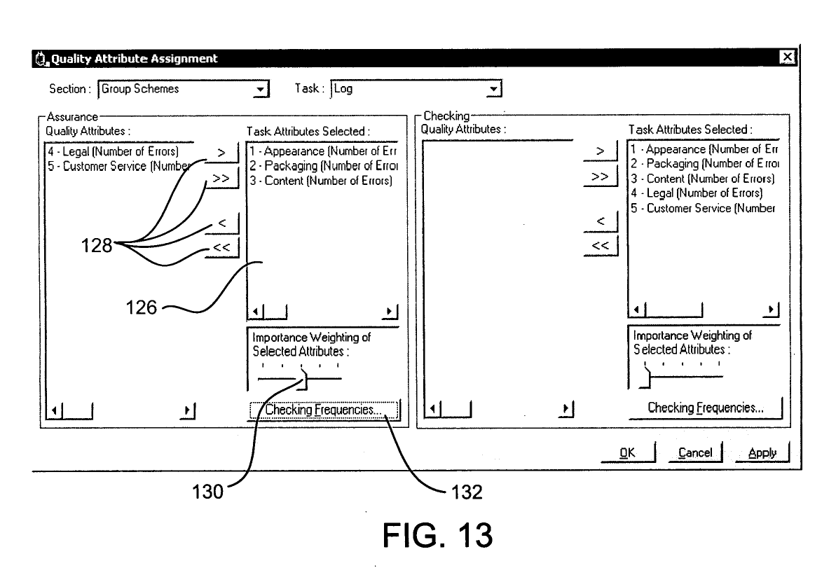

In some implementations, a user may monitor the quality of the tasks being completed. Task quality can be calculated as a function of the errors existing in a completed task. A user may select which type of errors to monitor, how often to look for the errors and how much weight may be given to each class of error. For example, as shown in FIG. 13, a user can select the type of error to monitor from the Task Attributes window 126. Once the error type has been selected, a user can transfer it to or from the Task Attributes selected window 126 using the Transfer buttons 128. A user may also change the weighting or importance of a particular type of error by adjusting the Attribute Weighting slide bar 130. In addition, a user may adjust the frequency in which an errors are checked by selecting the Check Frequencies button 132.

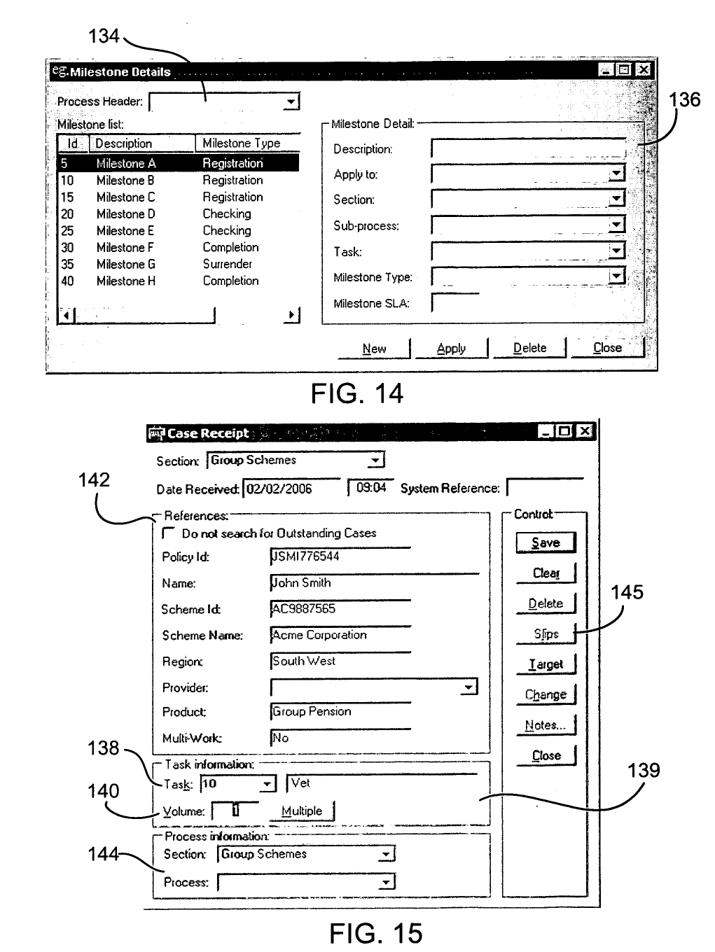

In other implementations, a user may establish notifications of pre-determined periods or events called milestones. The predetermined event may include, for example, the completion of a task, process or sub-process. FIG. 14 is an example of a milestone set-up screen. In the illustrated example of FIG. 14, a user can first select the process in which the milestones will be applied from the Process Header drop-down window 134. Milestone information may then be entered in the Milestone Data entry fields 136. Milestone information can include, for example: a description of the milestone; the section, task and sub-process to which the milestone is applied; and a milestone service level agreement (SLA). A service level agreement may include, for example, a scheduled date or range of dates agreed upon between a business and client for completing a task, sub-process or group of tasks and sub-processes.

Work Entry and Management

After setup of the system, a user, such as a manager or section leader, can enter new work received by the business into the database 4 at a work entry screen. FIG. 15 shows an example of a work entry screen designated “Case Receipt.” Work can be entered in this screen as a single item or as a set of multiple tasks entered in bulk. For example, a user may associate each work item with a specific task by selecting the task from the task information fields. The user can select the task identification number from the Task drop-down window 138. A description of the selected task may then be displayed in the Task Description field 139. In some instances, a manager or section leader may need to enter multiple tasks. For that reason, a user may enter a task volume in the Volume entry-field 140.

The data entered in the work entry screen can be defined by each section in order to list information that is the most relevant to that section. For example, in the illustration of FIG. 15, a user can enter reference information related to the work item in the Reference Data entry fields 142. The reference information can include but is not limited to, for example, the client name and geographic location, contact names, client and project identification numbers, and product name. In some implementations, the information entered into the Reference Date entry fields 142 of FIG. 15 may be obtained automatically by the system.

In addition, the work may be assigned to a specific section and/or process. For example, a user may select the section and process from the Process Information drop-down window 144. Furthermore, a user may enter a target date for completion of the work item and enter notes relevant to the work item. A hardcopy of the work receipt may be obtained by selecting the Slips button 145 to view and print.

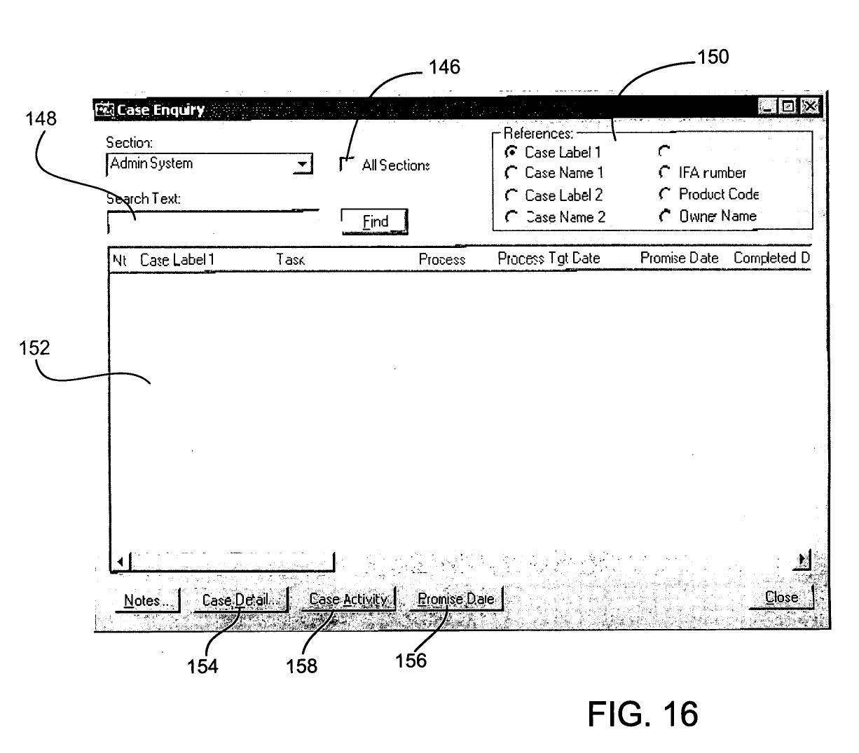

Alternatively, a manager or section leader may need to track the progress of a work item or to locate one or more work items that have been entered into the system. In this case, a user can perform a text search that examines the database and returns any work items relevant to the search term or terms. FIG. 16 shows an example screen, entitled “Case Inquiry” in which a user can search for previously entered work items. The search can be performed within a single section, for example, by selecting a team from a section drop-down window. A user may also search every section by checking the All Sections box 146. The text being searched can be entered in a Text entry field 148. The work item search may be further refined by limiting the search to a specific Reference field 150. Work items located by the search feature may be displayed in a Search Results window 152. A user can highlight a search result and select the Case Detail button 154 to view information associated with the work item. A user may also select the promise Date button 156 which returns the date a customer was informed that the process would be completed.

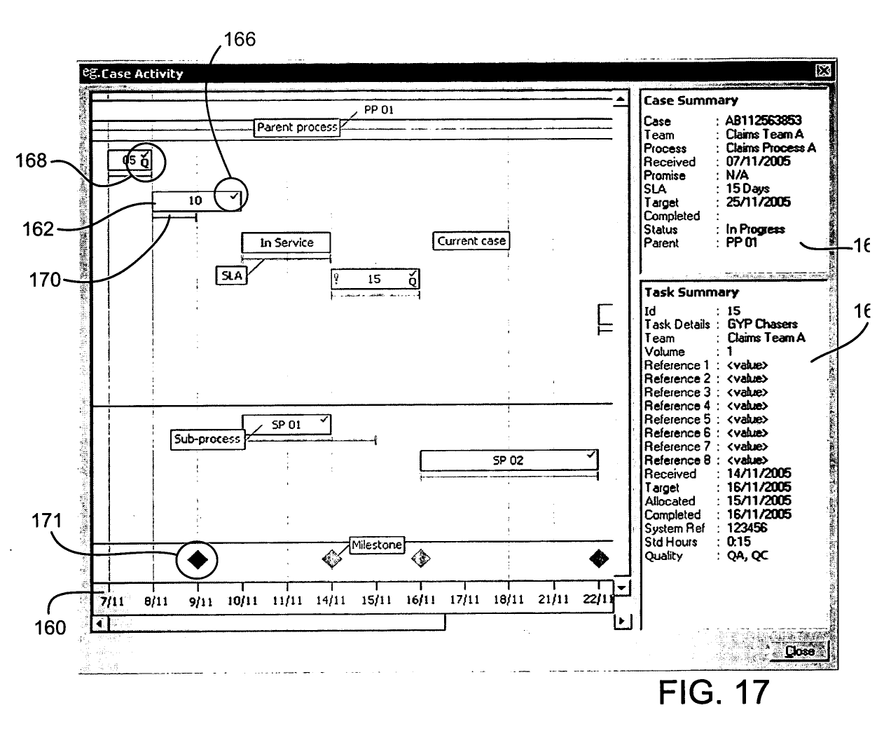

With the search result highlighted, a manager or section leader may select the Case Activity button 158. When the Case Activity button 158 is selected, a case activity screen is opened. FIG. 17 illustrates an example of a case activity screen. A case activity screen can display the history of the selected work item and the main or parent process to which the work item belongs. The case activity screen can also display other tasks and sub-processes that belong within the parent process. As an example, the Progress bars 162 plotted against Timeline 160 in the case activity screen of FIG. 17 indicate the tasks and sub-processes that have been completed, are currently being performed or that are scheduled. The case activity screen may also provide reference information on the tasks, sub-processes and parent process using Process and Summary windows 164.

A task or sub-process may be marked as completed in the case activity screen using, for example, a Check Mark symbol 166. A mark 168, such as the letter “Q”, may also be used to indicate whether sample data has been collected on a task or sub-process for quality assurance. Tasks and sub-processes may include a Service Level Agreement (SLA) line 170 plotted adjacent to the Progress bar 162 that indicates the service level agreement for completing the task or sub-process. SLA lines 170 may be color-coded to denote whether or not a task or sub-process has taken more time than specified by the service level agreement. In addition, Milestone markers 171 may be displayed at points along the timeline in the case activity screen. The milestone markers 171 may also be color-coded to indicate whether or not a milestone has been achieved.

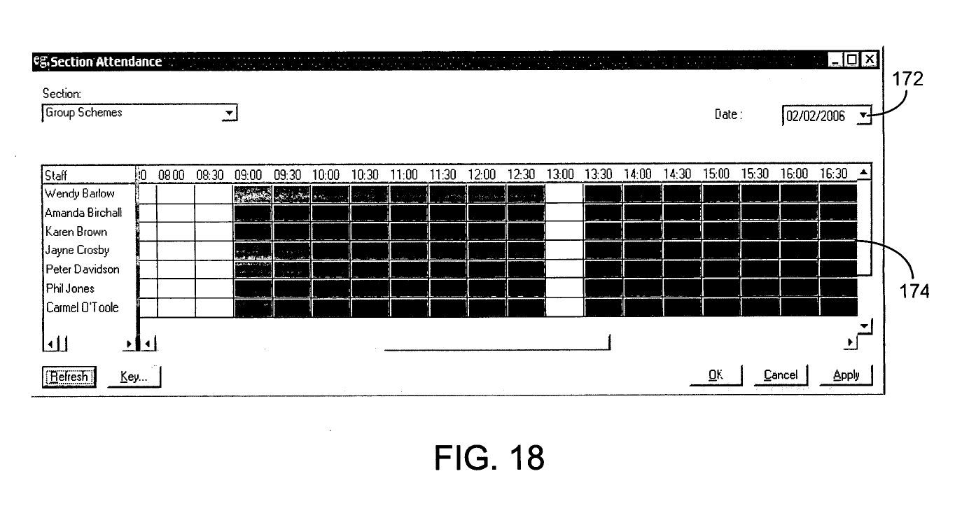

A manager, section leader or other staff member may also review staff attendance and availability details in a section attendance screen. FIG. 18 is an example illustration of a section attendance screen. The user can select which section to review from the section drop-down window as well as the date to review from the Date drop-down window 172. A Staff Attendance window 174 displays the work schedule for each staff member of the selected section. The work schedule may be viewed in a grid format indicating the availability of each staff member throughout a work day. For example, color-coding of the grid may be used to indicate that a staff member is sick, on vacation, in a meeting, at lunch, busy or free.

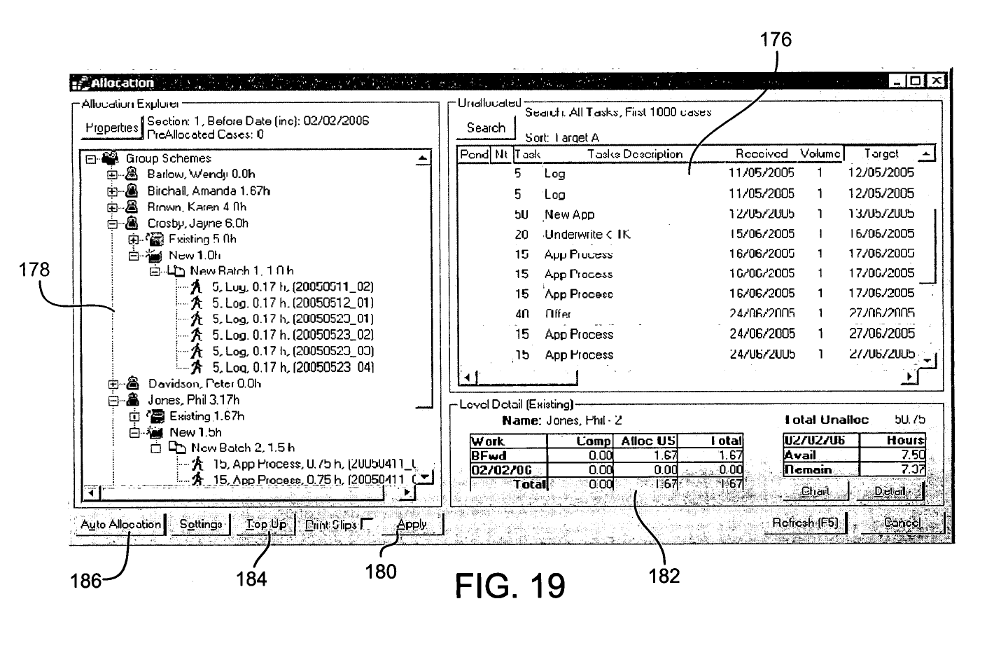

After assigning work to tasks, sub-processes and processes, the work may be allocated to staff members. Allocation of work may be performed manually or automatically in a work allocation screen. FIG. 19 illustrates an example of a work allocation screen. The work allocation screen may include a Task window 176 that lists tasks that can be allocated to staff members. The Task window 176 can include, for example, information such as task number, task description, the task volume, the date the task was received and the target date for completing a task. Tasks listed in the Task window 176 may be listed in order of priority, e.g., the most urgent tasks are presented at the top of the task list. The work allocation screen may also include an Allocation Explorer window 178. The Allocation Explorer window 178 preferably lists every section within the business. A user may expand the list to view each staff member within the sections.

Tasks may be allocated manually to staff members by selecting a task from the Task window 176, transferring the task to a staff member in the Allocation Explorer window 178 and selecting the Apply button 180. Tasks that have been transferred without selecting the Apply button 180 are listed as “new” tasks. After a user selects the Apply button 180, the tasks may be listed as “existing.” The time necessary to complete a task may be listed in the Allocation Explorer window 178 adjacent to the task description. Additionally, the total time of all the tasks allocated to each staff member may be listed adjacent to the staff member in the Allocation Explorer window 178. A Level Detail frame 182 may list the total working hours allocated to each staff member that have been brought forward (“BFwd”) from a previous date and that are allocated as of the current date. The Level Detail frame 182 may also indicate the total number of working hours remaining for the staff member for the current date as well as the current work period. The system may prevent a user from transferring tasks to staff members if the staff member does not have enough remaining hours left or the appropriate skill level to perform the tasks.

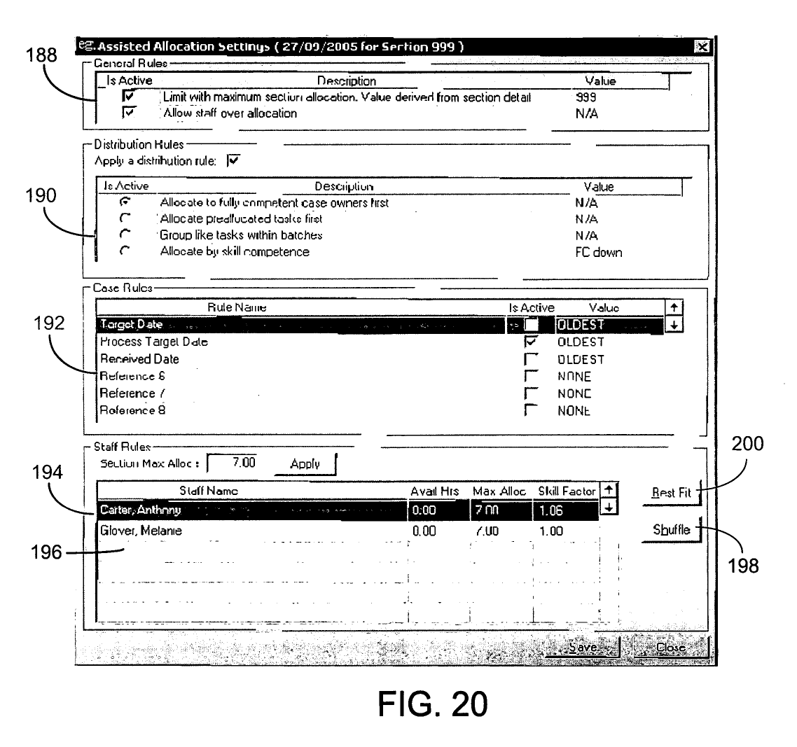

Alternatively, a user may allocate the tasks to a staff member automatically. For example, a user may highlight a staff member in the Allocation Explorer window 178 and then select the Top Up button 184 which automatically assigns non-allocated tasks to the staff member. Tasks may be allocated automatically according to a set of rules that a user selects in an auto allocation settings screen. A user may access the auto allocation settings screen by selecting the Auto Allocation button 186. FIG. 20 illustrates an example auto allocation settings screen. In the example illustration, a user may select rules from four separate categories: general rules; distribution rules; case rules; and staff rules.

The General Rules category 188 of the auto allocation screen allows a user to limit the total number of tasks assigned to a section or to allows allocation of tasks to staff members over their available time.

The Distribution Rules category 190 allows a user to select how the tasks are distributed by the system. For example, a user may select an auto allocation option that distributes tasks to the most competent or skilled staff members first. Alternatively, the user may select an auto allocation option that distributes pre-allocated tasks first. A user may also select an option that automatically groups similar tasks together in a batch of tasks.

The Case Rules category 192 allows a user to select how tasks are automatically distributed according to information entered in the work entry screen. This information can include the reference information of FIG. 14. For example, tasks may be allocated according to the target completion date of a task or by the received date of a task.

The Staff Rules category 194 allows a user to automatically distribute tasks according to the order in which they are listed in a Staff list 196. The user may shuffle the order of the staff member list by selecting the Shuffle button 198 or may arrange the staff members in order from most competent to least competent by selecting the Best Fit button 200. A user may also limit the number of hours a staff member is allocated by entering the hours into a Max Allocation entry field 202.

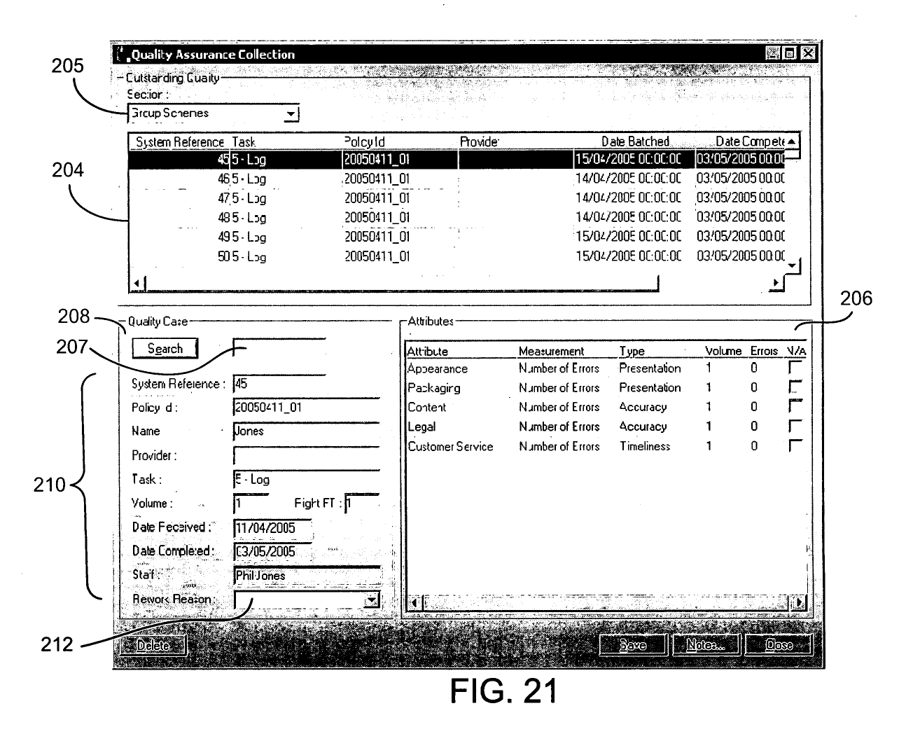

As discussed above, processes and tasks may be sampled to monitor the quality of the work performed. Typically, a after reviewing a completed item of work, a user enters the number of errors for each task in a quality entry screen (not shown). A section leader or manager may access the sampling results from a quality collection screen. An example illustration of a quality collection screen is shown in FIG. 21. The quality collection screen may include a Sampled Work window 204, an Attribute window 206 and a Search frame 208. Preferably, the user selects the section from the Section drop-down window 205 and a list of sampled work is shown in the Sampled Work window 204. From the Search frame 208, a user may search for a particular work item that has been sampled by entering data into the Text Entry field 207. Reference information for a work item selected in the Sampled Work window 204 may be displayed in the Reference fields 210 of the Search frame 208. Additionally, if a work item needs to be redone due to, for example, too many errors, a user may select a reason from a Rework drop-down window 212 in the Search frame 208. The errors for each attribute of a work item may be displayed in the Attribute window 206. Work item errors listed in the Attribute window 206 may include presentation errors, accuracy errors and errors due to completing the work item after the scheduled completion date.

Individual Work

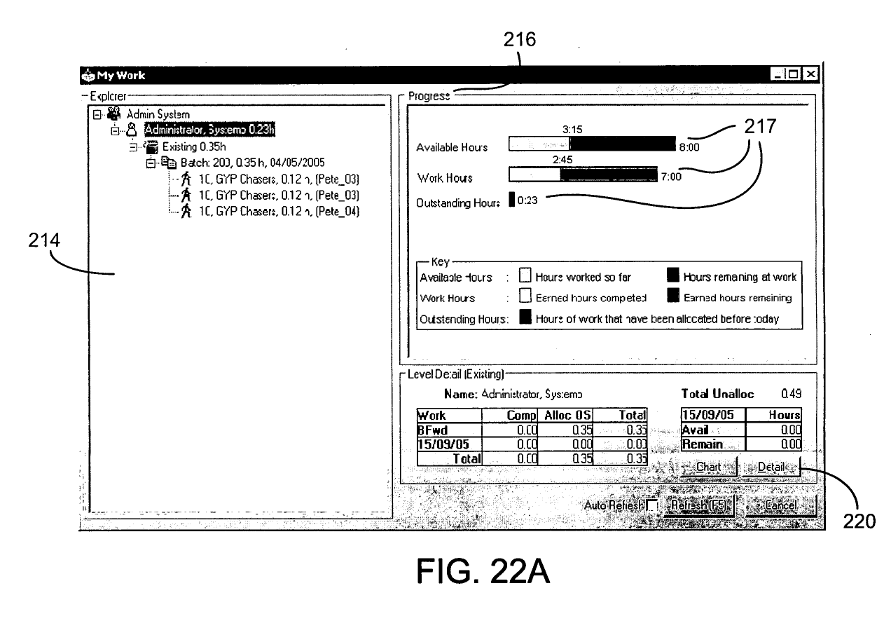

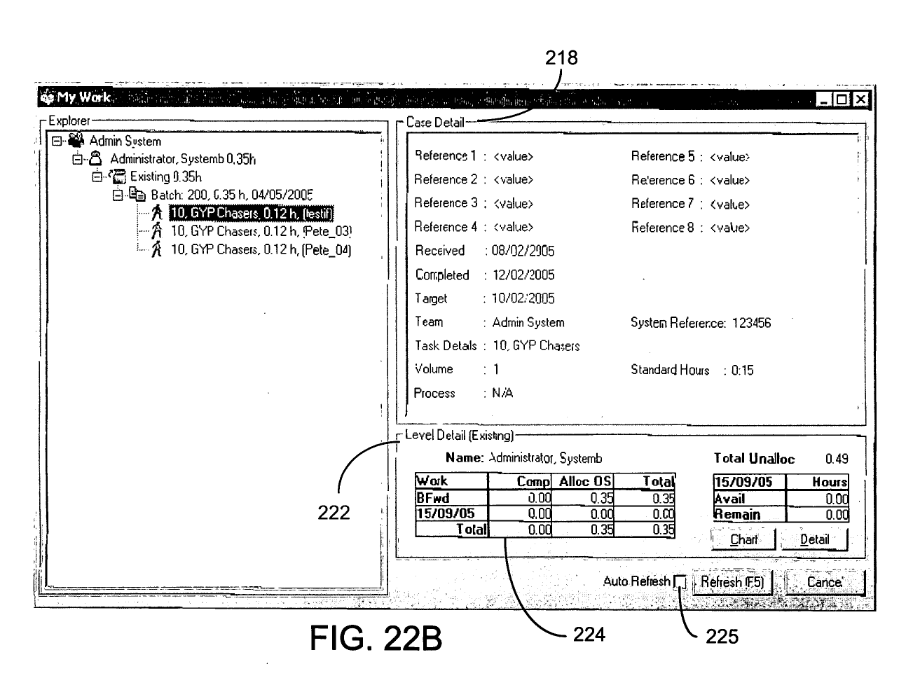

As discussed in the previous section, work items (tasks and sub-processes) may be allocated to the individual staff members of a business. A staff member may view the allocated items as well as his/her progress in a staff member work screen. FIG. 22A shows an example of a staff member work screen labeled “My Work.” A staff member work screen may include several windows: a Work Allocated window 214, a Progress window 216, and a Case Detail window 218 (FIG. 22B). The Work Allocated window 214 displays work that has been allocated to the staff member by a administrator such as a manager or section leader. In the example of FIG. 22A, the Work Allocated window 214 shows a list of existing tasks previously allocated to a staff member. Similar to the Allocation Explorer window 178 of FIG. 19, the Work Allocated window may display tasks previously allocated to the staff member in an expandable list. Each task illustrated in the window includes the task number and description as well as the time necessary to complete the task. The Work Allocated window 214 may also display the total work time, i.e., the cumulative time necessary to complete all tasks allocated on the present work day, as well as time that has been allocated prior to the present work day.

The Progress window 216 can provide a graphical display illustrating the hours worked by a staff member and the available hours remaining for the present work day. Additionally, the Progress window 216 may display any work that has been previously allocated prior to the current work day but not yet completed. For example, when a user selects a staff member name in the Explorer area (see FIG. 22A), the Progress window 216 displays a chart that includes several progress bars 217. The first progress bar, “available hours,” is a stacked bar graph that displays the total hours a staff member is scheduled to be at work (including, as an example, time for eating lunch, attending meetings and completing tasks) during the current work day and provides a color-coded comparison of the number of hours worked versus the number of hours remaining in the work day. The second progress bar, “work hours,” is also a stacked bar graph that displays the total number of hours a staff member is scheduled to perform work. Additionally, the “work hours” progress bar provides a color-coded comparison of the number of work hours earned, for example, by completing a task, versus the number of work hours unearned. The third progress bar, “outstanding hours,” indicates the time needed for work that has been previously allocated prior to the current work day but not yet completed.

A user may switch the display from the Progress window 216 in the staff member work screen to a Case Detail window 218 by selecting a particular task from the Work Allocated window 214. FIG. 22B illustrates an example of a Case Detail window 218. The Case Detail window 218 can display information relevant to a task that is selected in the work allocated window. This information can include, for example, the date the task was received in the system, the target date for completion of the task, the section to which the task is assigned, the task description, the task volume (i.e. the number of tasks to complete), the process to which the task is assigned, the time required to complete the task and any additional information that is entered for the selected task during the work entry step.

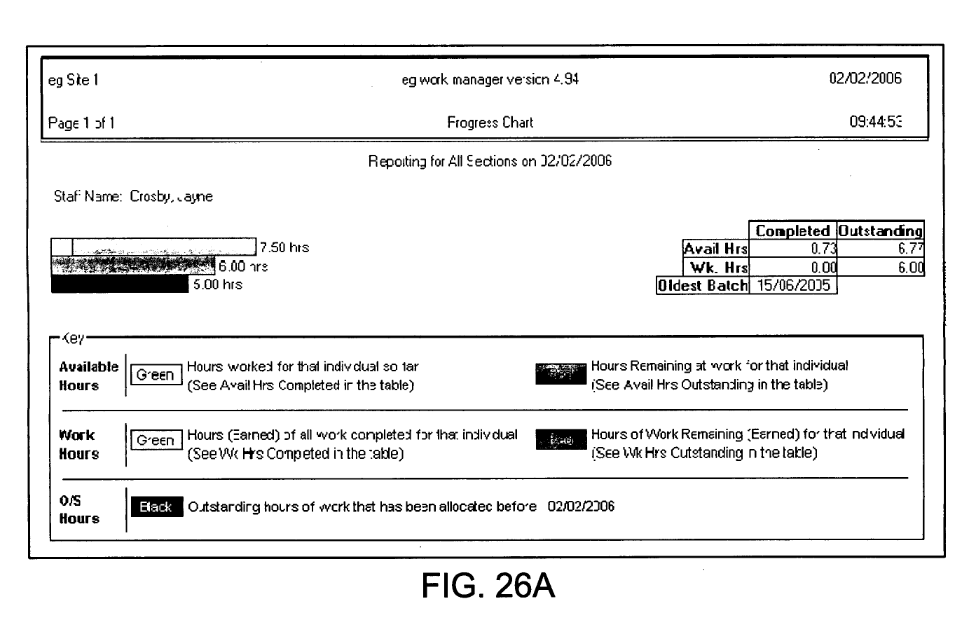

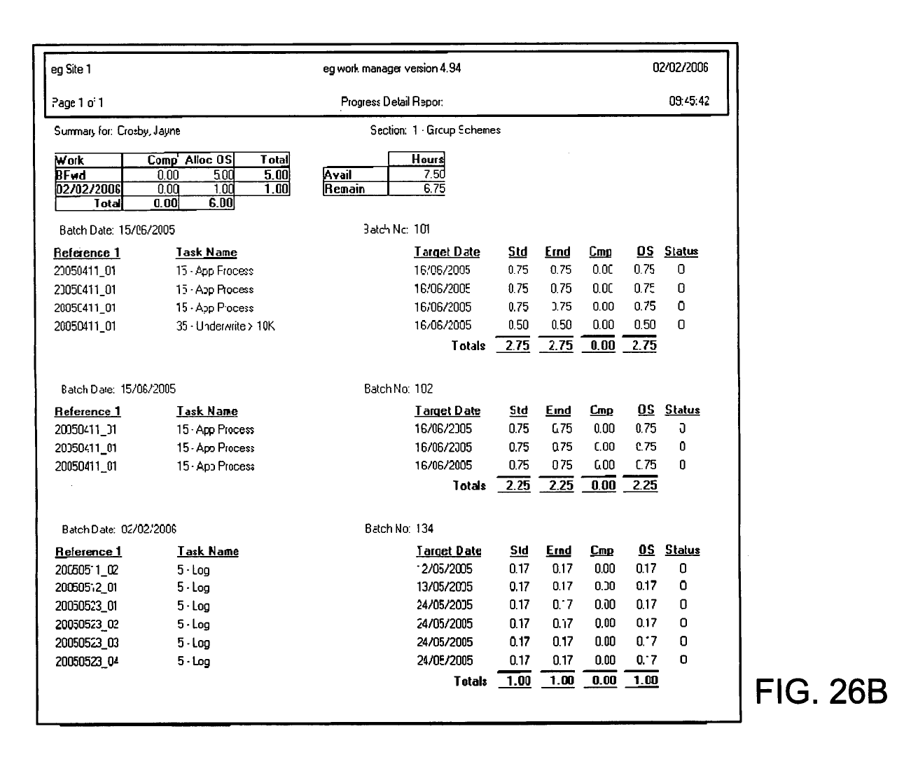

A staff member work screen may also include a Level Detail frame 222. The Level Detail frame 222 may display, for example, the staff member name and a spreadsheet 224 that lists the amount of work, in hours, completed and allocated to the staff member. The work may be further subdivided into work brought forward (“BFwd”) from a previous date and work assigned for the current work day. As shown in FIG. 22B, the Staff Level detail frame 222 may also list the available hours and remaining hours for the staff member as of the current work day. The information presented in the Progress window 216 and Level Detail frame 222 may be updated to provide the most recent data available by selecting the Refresh button 226. Alternatively, a user may select the Auto Refresh check box 225 so that the system automatically updates the Progress window 216 and Level Detail frame 222 with the most recent information. A Progress Detail report (see FIG. 26B, explained below) can be generated by selecting the Detail button 220.

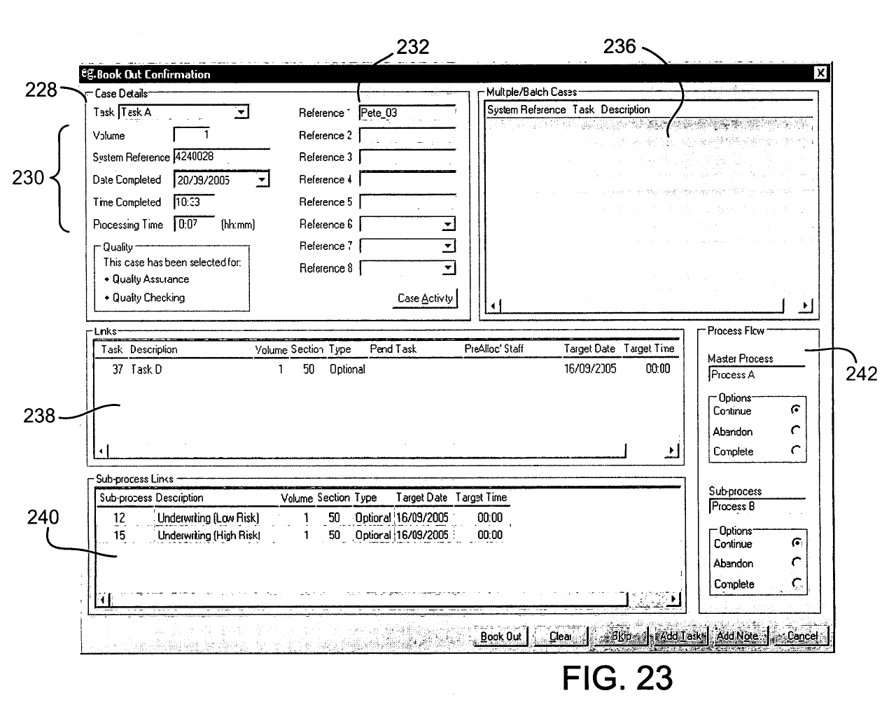

In order to notify the system that a task has been completed, a user preferably “books out” the task, i.e., the user may fill out and submit a Book Out Confirmation form. The system may then credit the user with the appropriate time for completing the task. During the book out procedure, the user may select a link to create the next task in a process. An example Book Out Confirmation window is shown in FIG. 23. A user may access the Book Out Confirmation window from the main toolbar or from the staff member work screen. From the staff member work screen, for example, a user may select a task and use the right-click feature of a mouse to open a link to the Book Out Confirmation window.

Once opened, the Book Out Confirmation window displays the task that will be booked out in the Task drop-down window 228 as well as corresponding task information in the Task Complete entry fields 230. The information included in the Task drop-down window 228 and entry fields 230 may be amended. For example, a staff member may change the task in the task drop-down window 228. Additionally, the date and time that a task was completed may be entered in the Task Complete entry fields 230. A staff member may also enter the amount of time necessary to finish the task in the process time field of the Task Complete entry fields 230. Furthermore, for tasks allocated in bulk, a staff member may enter the number of tasks completed in the volume entry field of the Task Complete entry fields 230. Additional notes or information may be entered in the Reference entry fields 232. A task may be officially “booked out” when the staff member selects the Book Out button 234 as shown in FIG. 23.

When a batch of work is “booked out,” the Book Out Confirmation window displays each task within in the batch in the Multiple/Batch Case window 236. A staff member then has the option to “book out” or “skip” each task in the list. In addition, the Book Out Confirmation window displays tasks or sub-processes that are linked from the booked out task in the Links 238 and Sub-Process Links 240 windows. The Book Out Confirmation window includes options for a user to continue, quit or complete a process or sub-process. These options may be selected in the Process Flow frame 242 of the Book Out Confirmation window. If there is still outstanding work that needs to be completed in a process or sub-process, the system may not allow a user to select the complete option in the Process Flow frame 242.

Reporting

Using the data provided in the setup, work entry, Book Out Confirmation window and other data entry screens described above, the system produces comprehensive reports that track work as it moves from receipt to completion in a process or sub-process; indicate staffing needs and requirements; detail individual staff member progress, performance and attendance; detail section progress and performance; illustrate work throughput, backlogs and quality; and forecast future work and staffing needs. A user may access reports from the tool bar 36 or menu bar 38 of the main screen.

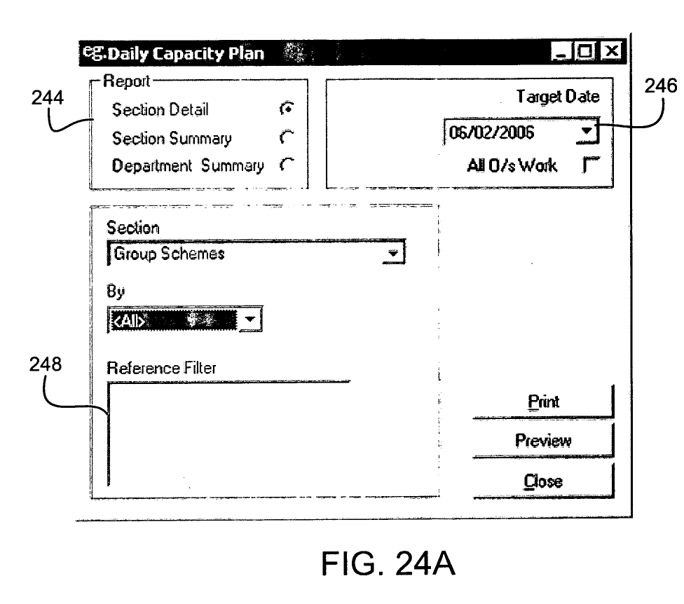

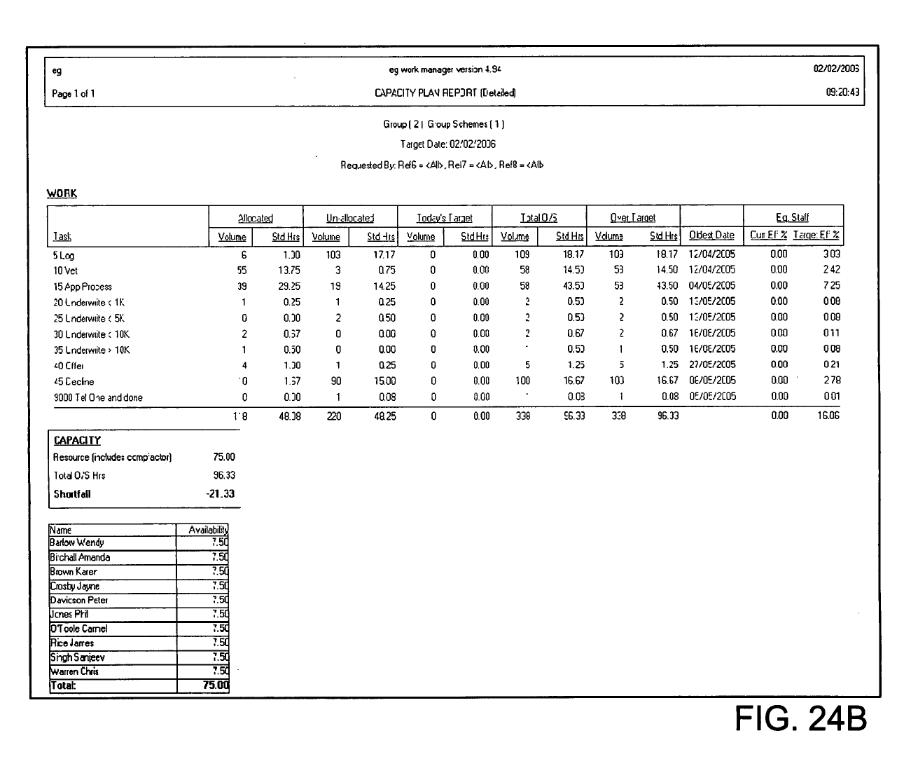

In one example, the system produces a capacity plan report that shows how much work exists for a section or department and how many staff members are required to complete the work. The work displayed in the report may include both allocated and non-allocated work for a specific target date. Preferably, the report also lists the availability of staff members within a selected section. A manager or section leader can use the information provided in this report to decide how to best utilize staff members so that work may be completed correctly and in a timely manner. An example capacity plan report generation window is illustrated in FIG. 24A. In the capacity plan report generation window, a user may select the section to display in the capacity plan report. Additionally, a user may select whether to display full section details, a section summary, or a department summary from the report frame 244. Section and department summaries provide the user with details on the capacity and availability of all sections or departments. Section and department summaries may allow a manager or section leader to view the availability of other sections in case they need to borrow staff members. The target date may be chosen from a Target Date drop-down window 246. The information displayed in the capacity plan report may be filtered by selecting a filters from the Reference Filter window 248. FIG. 24B illustrates an example capacity plan report.

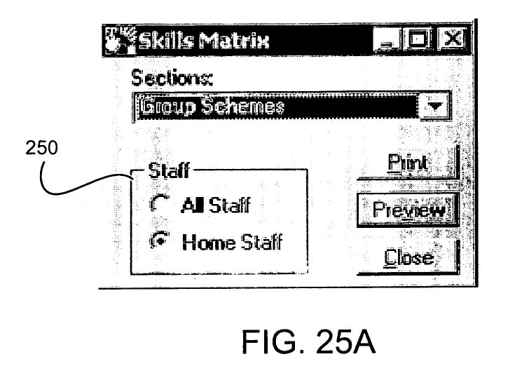

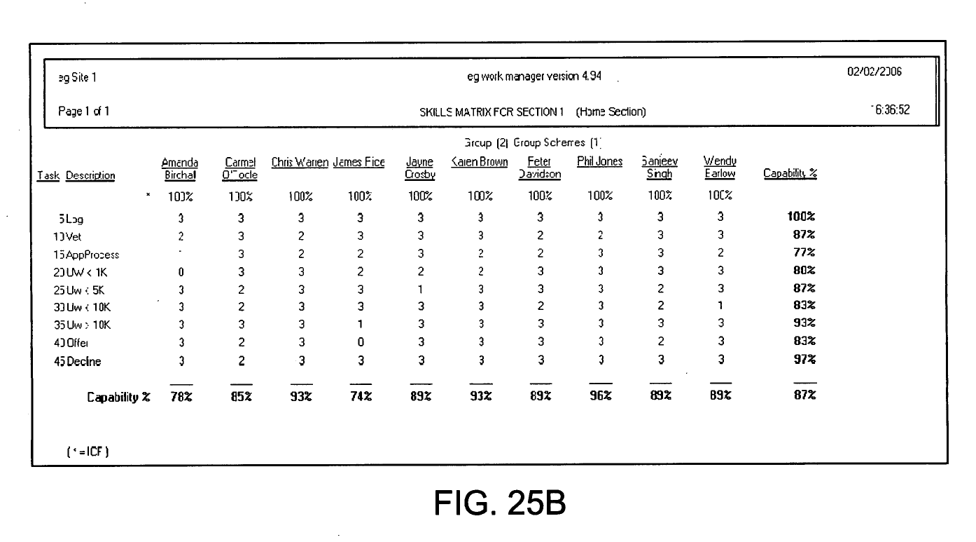

In another example, the system produces a skills matrix report. A skills matrix report shows the capabilities and skill level of each staff member within a section by task. An example skills matrix report generation window is shown in FIG. 25A. A user may select in the Staff frame 250, whether to display skills for staff across all sections or just for the section chosen. An example skills matrix report is shown in FIG. 25B.

In yet another example, the system produces progress charts for individual staff members. The progress charts may provide similar information as the staff member work screens of FIGS. 22A and 22B such as work hours, available hours, and outstanding hours. In addition the progress charts may list all tasks allocated to the individual staff member and provide specific task information that includes, for example, target date, hours completed, outstanding hours, earned hours and the standard number of hours for completing the task. FIGS. 26A and 26B illustrate example progress charts.

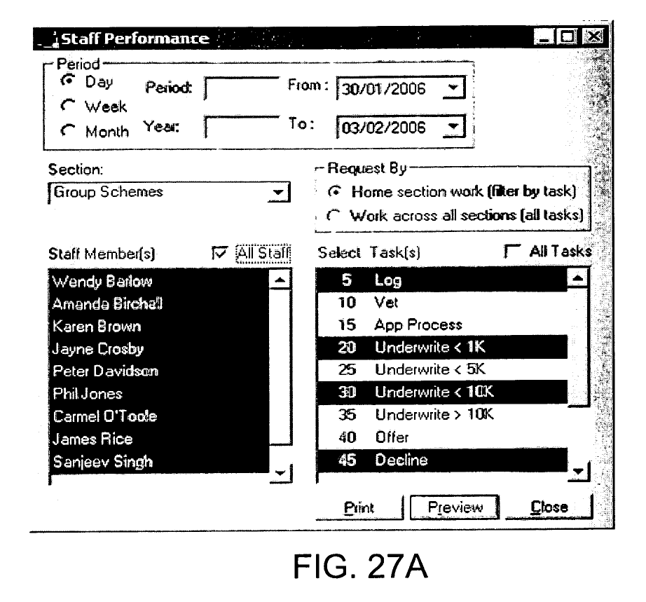

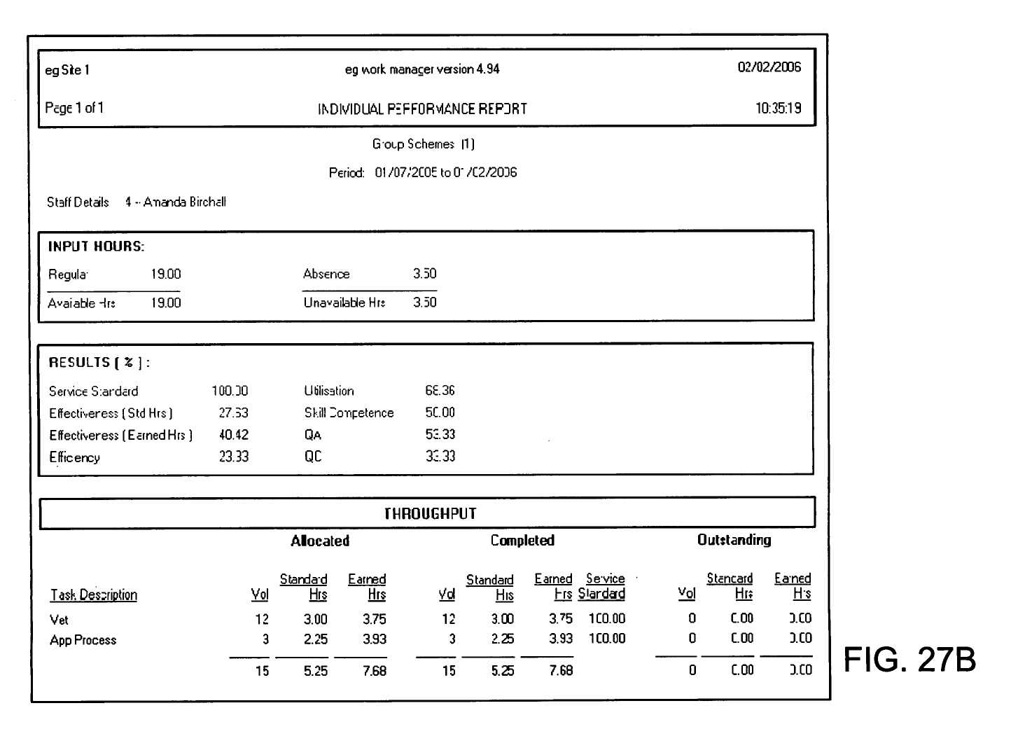

In still another example, the system creates individual performance reports. Individual performance reports can provide a manager or section leader with an indication of how time has been used by a staff member, how effective a staff member is at completing work, how efficient a staff member is at completing work on time, the staff member's quality of work and the skill level a staff member. An illustration of an example individual performance report generation window is shown in FIG. 27A. From the window of FIG. 27A, a user may select which section and staff members to view in an individual performance report. The user may also select to review data in the performance report for only a specific period of time (for example, a day, week, month, year, or other time period). In addition, a user may select to review the performance of staff members for only specific tasks or all tasks assigned to a section. An example individual performance report is shown in FIG. 27B.

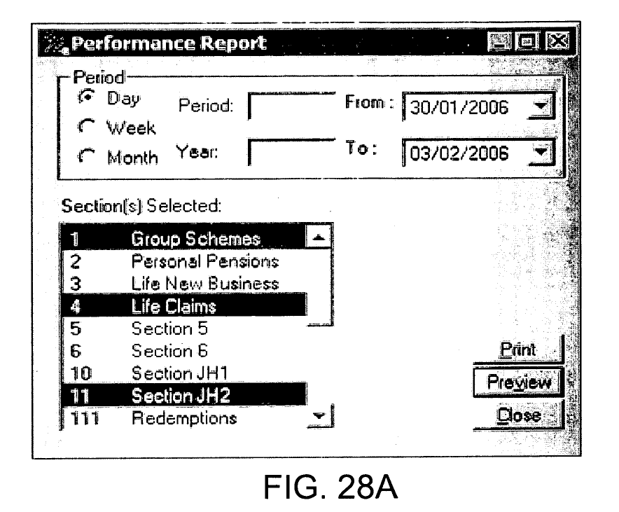

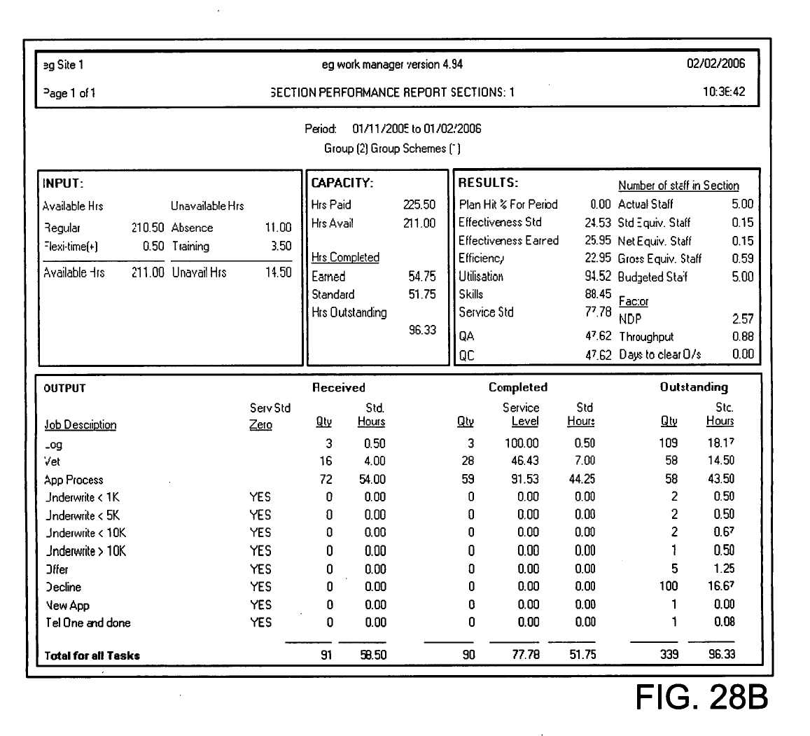

In another example, the system creates section performance reports. A section performance report can provide a manager or section leader with a performance evaluation of a section over a period of time. The performance evaluation may include, for example, which tasks were completed over the selected period, the number of tasks performed, the time necessary to perform each task, the section efficiency, the section effectiveness, the combined section skill level, the section staff available, the section hours outstanding and the section hours earned. An example illustration of a section performance report generation window is shown in FIG. 28A. A user may select from this window the sections to display in the section performance report as well as the performance report time period. FIG. 28B illustrates an example screen of a section performance report.

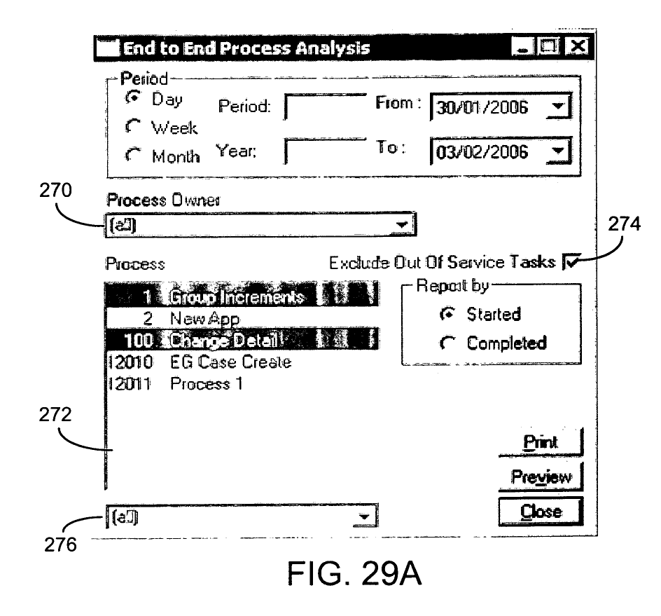

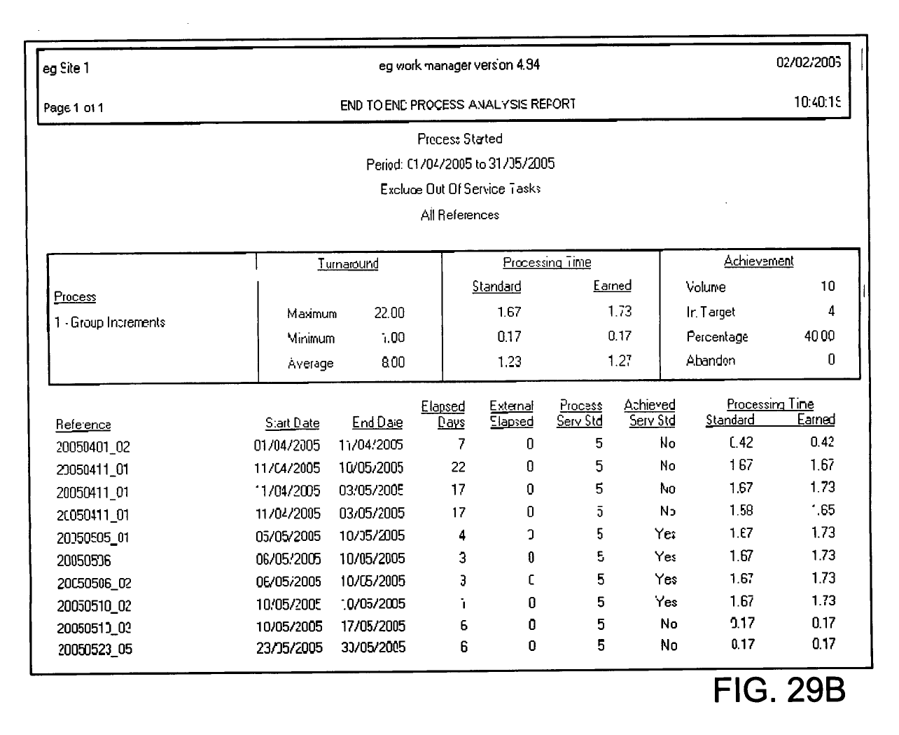

In yet another example, the system creates an end-to-end process analysis report. An end-to-end process analysis report may provide a user details of one or more processes over a period of time. The process details can include, for example, what tasks were completed or started; how many tasks were completed or started; what tasks were abandoned; the maximum, minimum and average turnaround times for a task; a comparison of the time needed to complete the tasks versus the standard time necessary to complete the tasks; and what percentage of tasks were completed by the target date. FIG. 29A illustrates an example of an end-to-end process analysis report generation window. From this window, a user may select which processes to display in the end to end analysis report as well as what time period to be represented in the report. The section that owns the process may be selected from the Process Owner drop-down window 270. Processes can then be selected from the Process List window 272. A user can select the Exclude Tasks check box 274 so that tasks which are not measured by a service standard are withheld from being displayed in the report. The report results may be filtered by selecting a filter from the Reference drop-down window 276. FIG. 29B illustrates an example end to end analysis report.

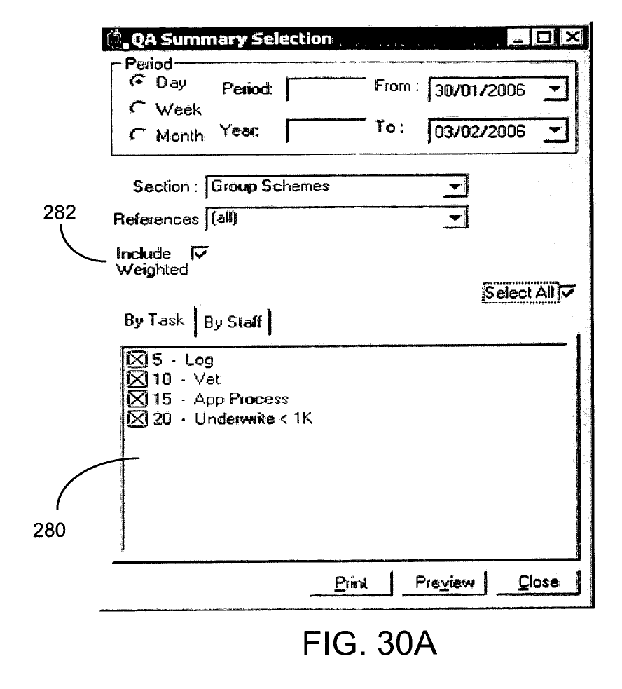

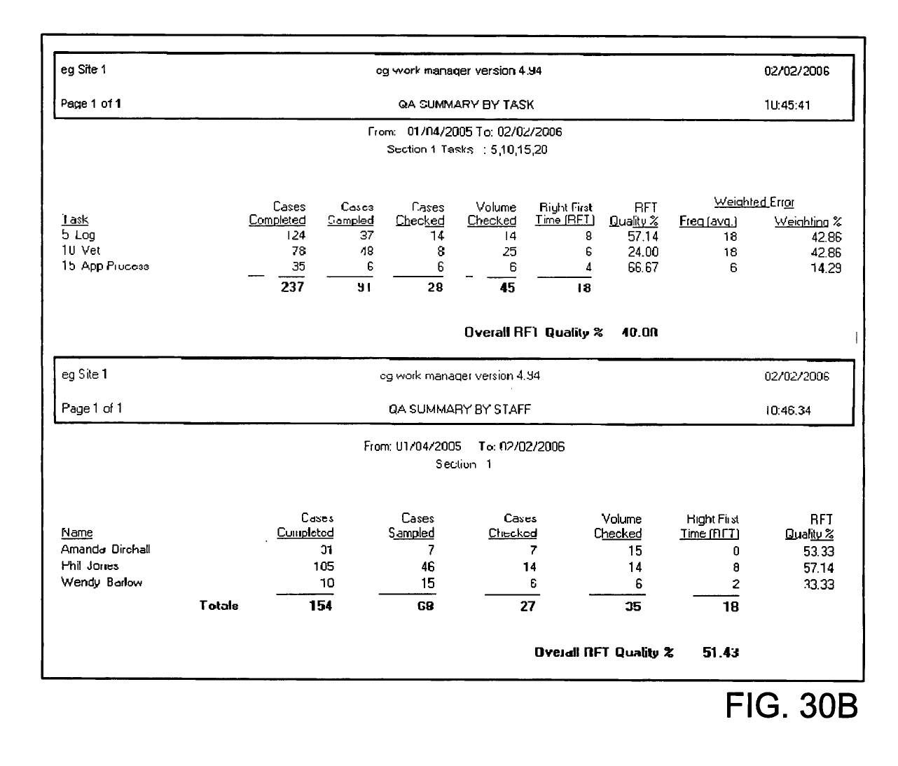

In another example, the system creates a quality summary report. A quality summary report may display performance evaluation by task or by staff member. The performance evaluation can include, for example, the number or percentage of tasks completed correctly the first time, the number of tasks completed, the number of tasks sampled and an overall quality percentage for the tasks or staff. FIG. 30A illustrates an example quality summary report generation window. From this window, a user may select whether to display staff members or tasks in the quality summary report from the selection window 280. If a user wants to include the weighting information on the report, the user may select the include Weighting check box 282. Additionally, a user may select the time period for the quality summary report. An example quality summary report is illustrated in FIG. 30B.

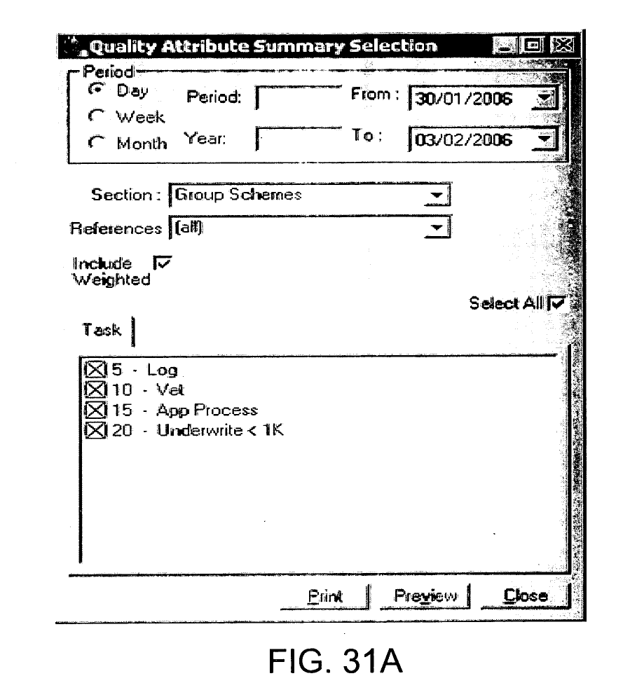

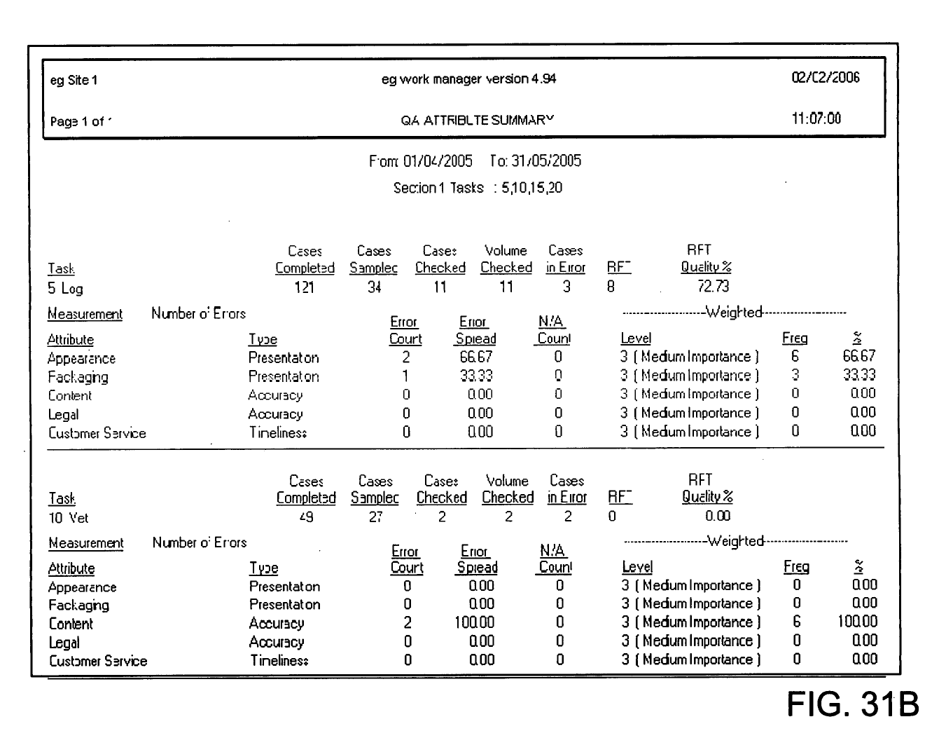

In still another example, the system creates a quality attribute summary report. A quality attribute summary report may display the quality level for specific attributes of one or more tasks over a period of time. The attributes can include, for example, the presentation, accuracy, completeness and timeliness of a completed task. FIG. 31A illustrates an example quality attribute summary report generation window. From this window, a user may select the section, time period and tasks to display in the report as well as whether the quality level should or should not be weighted. An example quality attribute summary report is shown in FIG. 31B.

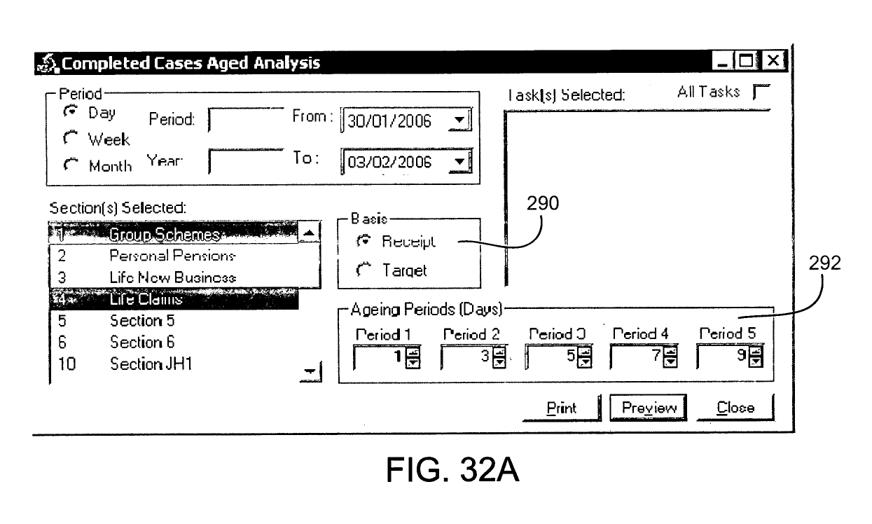

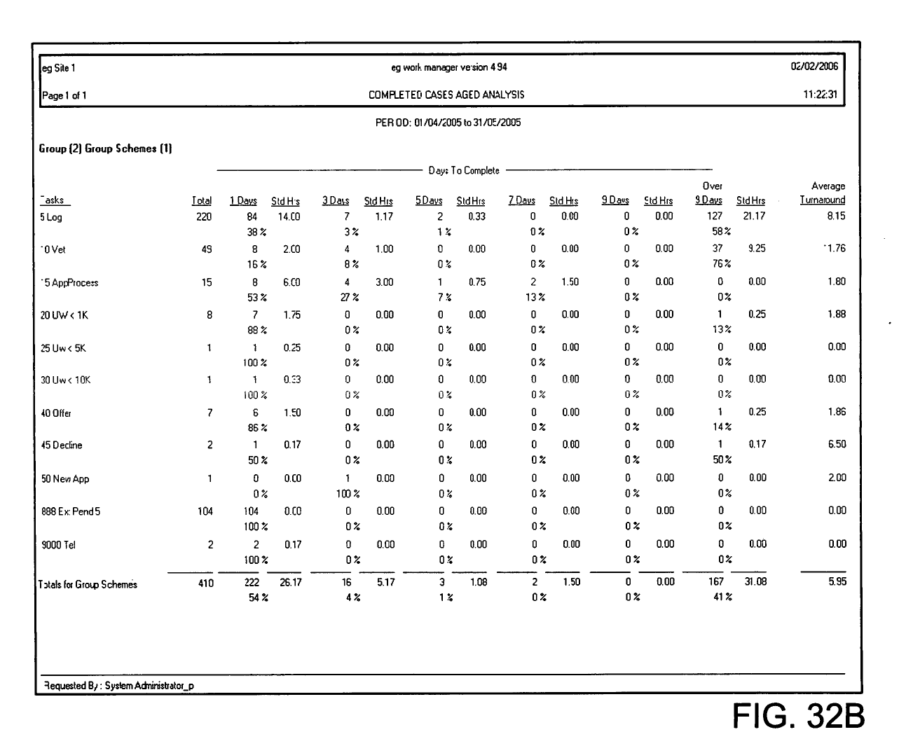

In another example, the system creates an age analysis report. An age analysis report may display the time elapsed for completing tasks based on the receipt date or target date. An example of an age analysis report generation window is shown in FIG. 32A. From this window, a user may select which tasks to report and from what time period the tasks are selected. Additionally, a user may select in the Basis frame 290 whether to display the elapsed time as measured from the task receipt date or from the task target date. Furthermore, a user may choose to display the elapsed time for each task as a distribution over a period of time from the Ageing Periods entry fields 292. An example ageing analysis report is shown in FIG. 32B. The illustrated report presents each selected task as well as the variation in number of days elapsed until the task has been completed. Additionally, the report may show the total number of tasks completed, the total number of hours required to complete the tasks and the average number of days elapsed until the task is completed.

Manager Reporting Tool

In addition to reviewing reports from the operation software, a user may access these reports from a web-enabled browser through the client computer 1. The web-enabled browser can be used as a reporting tool that is directed towards mid-level and senior managers of a business. The data displayed by the browser can be an immediate replication of the data stored in the single or multiple databases 4 of the system. The browser can allow users to view and analyze work flow and performance for an entire business or only specific business units from the section level and above in graph format or in a spreadsheet format. The browser is a modular application that includes: a dashboard module that allows a user to view a “snapshot” of work flow and performance; a reporting module that allows users to view and print reports or export the data from the reports to a file; an enquiry module that allows a user to search for and track work items such as processes, sub-processes or tasks; an attendance module that allows a user to monitor section and staff member attendance or modify section and staff member working hours; a quality module that allows a user to create, assign, search and review results from questionnaires that are directed to a business's clients and customers or to staff members within a business; an administration module that allows users, preferably system administrators, to set up and maintain the web enabled browser; and a security module that allows users to set up and maintain user information and passwords as well as log out of the browser.

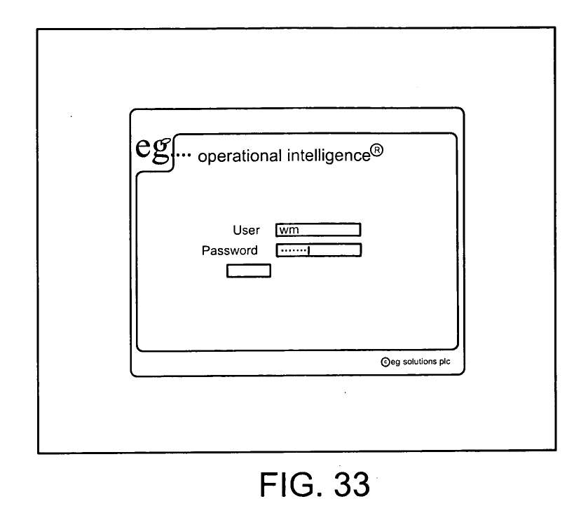

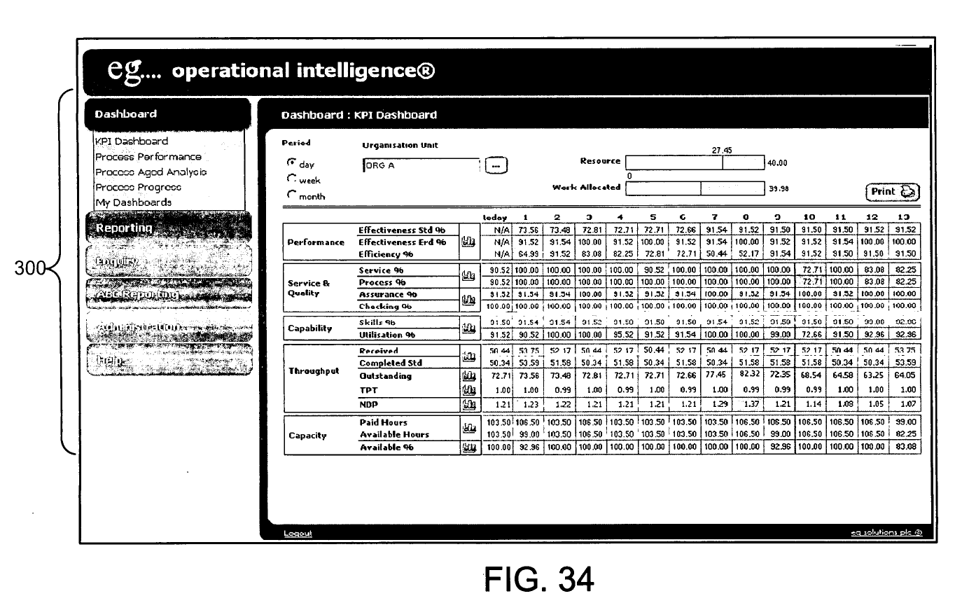

After opening the browser, a user may access the modular applications by entering the user's login information into a login screen such as the example screen of FIG. 33. The browser may then display a list 300 of module applications on the client computer 1 as shown in FIG. 34.

When the user selects the dashboard module application, the browser may list several different types of available reports from which the user can choose. For example, the dashboard module may include a process performance report, a process aged analysis report, a process progress report, and a key performance indicator (KPI) report. FIG. 34 is an example of a KPI report. A KPI report may provide information on several different business indicators for any business unit down to the section level and over a period of days, weeks or months. The business indicators can include, for example, performance indicators which may indicate the effectiveness and efficiency of the selected business unit, service and quality indicators, capability indicators which may include the business unit skill level, throughput indicators which may include processes received and completed by the business unit, and capacity indicators which may include the available hours and paid hours of a business unit. In addition, the KPI report may color-code the indicators to designate which indicators are performing above and below predetermined values.

The process performance report, process aged analysis report and process progress report preferably provide the same information as the end-to-end analysis and ageing analysis reports of FIGS. 29B and 32B. Process and task information may be displayed over a selected time frame such as a day, week or month for different units and for different geographic regions of the business. This information can include the volume and hours required to complete the received tasks; the hours of work performed to complete tasks; the volume of the completed tasks; a completed tasks goal and task achievement level that may be viewed by persons external to the business, such as clients and customers; a completed tasks goal and achievement level that may be viewed by persons who work within the business; The volume and hours of work that is outstanding, i.e., incomplete.

The reporting module allows a user to select and view reports that present information similar to the reports mentioned above including, for example, a capacity plan report, a skills matrix report, an individual progress report, individual and section performance reports, milestone reports, quality summary reports and attribute reports.

The enquiry module allows a user to track the progress or locate one or more work items similar to the case enquiry and case activity screens described above with reference to FIGS. 15 and 16.

The attendance module allows a user to view and modify staff member attendance schedules similar to the attendance entry screens described above with reference to FIGS. 17 and 18.

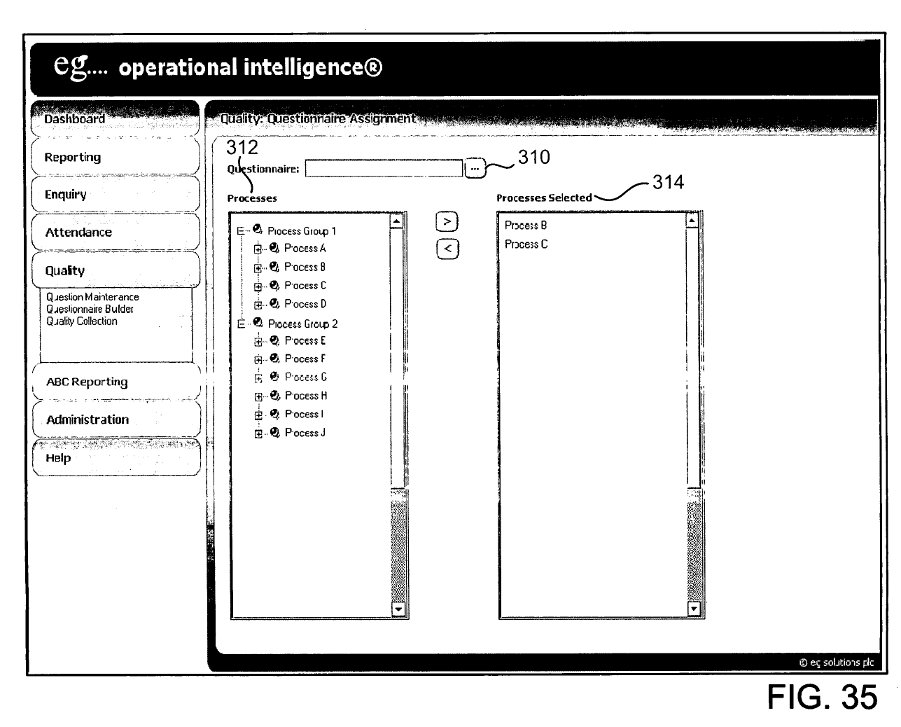

The quality module allows a user to create questionnaires, assign questionnaires to staff members, sections, processes, customers and clients, and review questionnaire responses. A user may include, for example, multiple-choice, text entry or scoring questions in the questionnaire. The question responses may be weighted and scored. The questionnaires may be sampled randomly or manually collected. An example of a questionnaire assignment screen is shown in FIG. 35. In the illustrated example, a user may select the appropriate questionnaire from the questionnaire selection field 310. A user may then choose which process to assign the questionnaire to by selecting from the process list 312. The questionnaire may then be assigned by transferring the chosen item or items to the processes selected list 314.

Various aspects of the system may be implemented in hardware, software or a combination of hardware and software. Circuitry, including dedicated or general purpose machines, such as computer systems and processors, may be adapted to execute machine-readable instructions to implement the techniques described above. Computer-executable instructions for implementing the techniques can be stored, for example, as encoded information on a computer-readable medium such as a magnetic floppy disk, magnetic tape, or compact disc read only memory (CD-ROM).

A number of embodiments of the invention have been described. Nevertheless, it will be understood that various modifications may be made without departing from the spirit and scope of the invention. Accordingly, other embodiments are within the scope of the following claims.

What is claimed is:

1. A system for monitoring the flow of work comprising:
a communication network;
one or more user devices connected to the communication network, the user devices including displays;
a database storing setup information, tasks to be performed and completed task information;
one or more servers connected to the communication network and configured to:
present on each of the displays, via the communication network, an interactive program wherein the interactive program allows users to enter into the database, the setup information, the tasks to be performed and the completed task information, and
deliver information to the user device through the communication network in response to receiving a request by a user, wherein the delivered information includes at least one of the following: a task allocated to a user, task information, staff member information, a report based on the setup information and completed task information, and forecasting information.

2. The system of claim 1 wherein the setup information comprises department information, section information and staff member information.

3. The system of claim 1 wherein the completed task information comprises the quality of each completed task, a time stamp of when each task was completed and an amount of time taken to complete each task.

4. The system of claim 1 wherein the one or more servers are configured to:
allocate a task to a user automatically based on at least one of the following: availability of the user, attendance schedule of the user and skill level of the user.

5. The system of claim 1 wherein the one or more servers are configured to:
automatically allocate a second task to a user designated to perform the second task based on completion of a first task.

6. The system of claim 5 including allocating the second task to the user designated to perform the second task after at least one of the following: a predetermined period of time has elapsed since completion of the first task or a due date for completion of the first task has passed.

7. The system of claim 1 wherein the one or more servers are configured to:
automatically allocate a second group of tasks to users designated to perform the second group of tasks after completion of a first group of tasks.

8. The system of claim 7 including allocating the second group of tasks after at least one of the following: a predetermined period of time has elapsed since completion of the first group of tasks or a due date for completion of the first group of tasks has passed.

9. The system of claim 1 wherein the one or more servers are configured to:
determine an amount of time to complete each task based on a skill level of the user designated to perform the task; and
determine a number of users to complete the tasks based on skill levels of users available to perform the tasks and difficulty of the tasks to be performed.

10. The system of claim 1 wherein the one or more servers are configured to:
determine future staffing needs based on at least one of the following:
volume of the tasks to be performed, difficulty of the tasks to be performed or scheduled completion dates for the tasks to be performed.

11. The system of claim 1 wherein the one or more servers are configured to:
determine a task quality based on errors committed by a user performing the task.

12. The system of claim 1 wherein the one or more servers are configured to:
determine a performance of a user based on a skill level of the user, how often the user completes each task on time and a quality of each task completed by the user.

13. The system of claim 1 wherein the report is a graphical report and displays at least one of the following: status of both allocated and unallocated tasks, staffing levels, staff member attendance, staff member skills, staff member progress and performance, section progress and performance, department progress and performance, quality of completed tasks, staff member cost information, work cost information and department, section or staff member trends.

14. A computer-implemented method for tracking flow of work comprising:
storing setup information in a database, wherein the setup information includes tasks to be performed;
allocating the tasks to users designated to perform the tasks;
storing details of completed tasks in the database; and
delivering information to users that includes at least one of the following: task information, staff member information, a report based on the setup information and the details of completed tasks or forecast information.

15. The computer-implemented method according to claim 14 including:
displaying the delivered information on a computer.

16. The computer-implemented method according to claim 14 wherein each task is allocated to a user based on availability and attendance schedule of the user.

17. The computer-implemented method according to claim 14 wherein each task is allocated to a user based on a skill level of the user.

18. The computer-implemented method according to claim 14 including:
allocating a second task to a user designated to perform the second task based on completion of a first task.

19. The computer-implemented method according to claim 18 including allocating the second task to the user designated to perform the second task at a predetermined period of time after completion of the first task.

20. The computer-implemented method according to claim 18 including allocating the second task to the user designated to perform the second task after a due date for completion of the first task has passed.

21. The computer-implemented method according to claim 14 including:
allocating a second group of tasks to users designated to perform the second group of tasks after completion of a first group of tasks.

22. The computer-implemented method according to claim 21 including allocating the second group of tasks at a predetermined period of time after completion of the first group of tasks.

23. The computer-implemented method according to claim 21 including allocating the second group of tasks after a due date for completion of the first group of tasks has passed.

24. The computer-implemented method according to claim 14 including:
determining an expected amount of time to complete each task based on a skill level of the user designated to perform the task.

25. The computer-implemented method according to claim 14 including:
determining a number of users to complete the tasks based on skill levels of users available to perform the tasks and difficulty of the tasks to be performed.

26. The computer-implemented method according to claim 14 including:
determining future staffing needs based on at least one of the following: volume of the tasks to be performed, difficulty of the tasks to be performed and scheduled completion dates for the tasks to be performed.

27. The computer-implemented method according to claim 14 including:
determining a quality of each task performed based on errors committed by a user performing the task.

28. The computer-implemented method according to claim 14 including:
determining a user's performance based on a skill level of the user, how often the user completes a task on time and quality of the tasks completed by the user.

29. The computer-implemented method according to claim 14 including:
determining performance of a group of users based on at least one of the following: a combined skill level of the users in the group, quality of tasks completed by the users in the group, users available in the group, how often each user in the group completes a task, number of tasks performed by the group, number of tasks outstanding or number of hours worked by the group.

30. The computer-implemented method according claim 14 wherein allocation of tasks is based on a volume of tasks to be performed and scheduled completion dates for the tasks.

31. The computer-implemented method according to claim 14 wherein the report is a graphical report and displays at least one of the following: status of both allocated and unallocated items of work, staffing levels, staff member attendance, staff member skills, staff member progress and performance, section progress and performance, department progress and performance, quality of completed work, staff member cost information, work cost information and department, section or staff member trends.

32. An article comprising a machine-readable medium storing machine-executable instructions that, when applied to a machine, cause the machine to:
store setup information in a database, wherein the setup information includes tasks to be performed;
allocate, through a communication network, the tasks to users designated to perform the tasks;
store details of completed tasks in the database; and
deliver information based on the setup information and the details of the completed tasks,
wherein the delivered information includes at least one of the following: a task allocated to a user, task information, staff member information, a report based on the setup information and completed task information, or forecasting information.

33. The article of claim 32 including instructions that, when applied to the machine, cause the machine to:
automatically allocate a task to a user based on at least one of the following: availability of the user, attendance schedule of the user and skill level of the user.

34. The article of claim 32 including instructions that, when applied to the machine, cause the machine to:
automatically allocate a second task to a user designated to perform the second task after completion of a first task.

35. The article of claim 32 including instructions that, when applied to the machine, cause the machine to:
automatically allocate a second group of tasks to users designated to perform the second group of tasks after completion of a first group of tasks.

36. The article of claim 32 including instructions that, when applied to the machine, cause the machine to:
determine an expected amount of time to complete each task based on a skill level of the user designated to perform the task and
determine a number of users to complete the tasks based on skill levels of users available to perform the tasks and difficulty of the tasks to be performed.

37. The article of claim 32 including instructions that, when applied to the machine, cause the machine to:
determine future staffing needs based on at least one of the following: volume of the tasks to be performed, difficulty of the tasks to be performed and scheduled completion dates for the tasks to be performed.

38. The article of claim 32 including instructions that, when applied to the machine, cause the machine to:
determine a task quality based on errors committed by a user performing the task.

39. The article of claim 32 including instructions that, when applied to the machine, cause the machine to:
determine a performance of a user based on a skill level of the user, how often the user completes each task on time and a quality of each task completed by the user.

40. The article of claim 32 wherein the report is a graphical report that displays at least one of the following: status of both allocated and unallocated tasks, staffing levels, staff member attendance, staff member skills, staff member progress and performance, section progress and performance, department progress and performance, quality of completed work, staff member cost information, work cost information and department, section or staff member trends.
